(19) United States
(12) Patent Application Publication
(10) Pub. No.: US 2003/0028592 A1
(43) Pub. Date: Feb. 6, 2003

(54) Backup-restoration system and right management server

(76) Inventors: Masahiro Ooho, Neyagawa-shi (JP); Masaya Yamamoto, Hirakata-shi (JP); Kouji Miura, Matsubara-shi (JP); Ryuichi Okamoto, Moriguchi-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/208,036

(22) Filed: Jul. 31, 2002

(30) Foreign Application Priority Data
Aug. 3, 2001 (JP) 2001-236029
Jan. 28, 2002 (JP) 2002-017928

(51) Int. Cl. G06F 15/16

(52) U.S. Cl. 709/203; 709/219

(57) ABSTRACT

A terminal (140) attaches a client ID and a whole or a part of LT to a backup request and sends them to a right management server (710). A right management server (710) verifies the client ID to see when the entity originating the request is an registered user, and it also verifies data identification ID on the LT to see when right data is the one issued by the server for the registered user, and then performs backup for the right data when the right data is the one issued by the server. The terminal (140) attaches the client ID to a restoration request and sends them to the right management server (710). The right management server (710) checks a user ID from the client ID, and then restores the right data to the terminal (140), which is backed-up in association with the user ID.

### TECHNICAL FIELD

The present invention relates to a data backup-restoration system, especially relates to a data backup-restoration system in a client-server type system.

### BACKGROUND ART

Up to the present, for data stored in a terminal, an external media such as a CD-R (Compact Disc Recordable), an MO (Magneto Optical) disk or a server connected via a network have been used for backup and restoration of backed-up data in preparation for a case if the data is lost, damaged or updated incorrectly by some operational mistake.

Normally, the data backed-up in the external media or the server is often the data valuable for its data owner. Therefore, the backup data should not be restored and used by someone else. Especially, if the backup data is the data for which copyright is reserved, it must not be available for others to restore and use illegally for protecting the copyright of the data provider.

As a method to resolve above problem, in the Japanese Laid-Open Patent Application No. 2-287835, control is provided through user authentication using a user ID and a password when a backup-restoration is executed. Also, according to the Japanese Laid-Open Patent Application No. 11-220718, identification information unique to a terminal is recorded with a linkage to the data for backup. When the data is to be restored, whether or not the terminal holds the identification information is judged and the restoration is available only to the terminal containing the information.

However, the backup-restoration control with the user authentication is vulnerable from a security point of view since restoration can be done by anyone whoever happens to know its user ID and password. Also, in the backup-restoration control with associated terminal unique identification information, where the backup data is associated with the identification information of the terminal executing the backup, it is difficult to restore the data on other terminal if the terminal executing the backup is broken.

In consideration of the aforementioned problems, the present invention aims at providing a backup-restoration system that easily restores the backup data even if the terminal executing the backup is broken.

### DISCLOSURE OF INVENTION

In order to resolve the above issues, a backup-restoration system of the present invention comprises a terminal device using content as digital production and a server device managing usage of the content in the terminal device via a communication network, wherein the server device includes: a right information memory unit operable to memorize right information regarding a usage right of content owned by a user who uses the terminal device; a license ticket issuance unit operable to generate a license ticket that is right information indicating a part of the usage right owned by the user and issue the license ticket to the terminal device based on a request from the user; a judgement unit operable to judge whether or not the right related to a backup request from the terminal device is based on the license ticket issued by the server device; and a backup unit operable to internally hold the right information indicating the usage right related to ownership at the time of the backup request from the user when the right related to the backup request from the terminal device is based on the license ticket issued by the server device as a result of the judgement, and the terminal device includes: a license ticket storage unit operable to store the license ticket sent from the server device; a content usage control unit operable to control the content usage according to the usage right indicated on each license ticket stored; and a backup request unit operable to request backup of the usage right currently owned by the user based on the license ticket stored.

In the backup-restoration system of the present invention, the server responds to the backup request from the terminal as long as the request is for the right based on the license ticket issued by the same server, which is different from a case to perform backup for the right based on the license ticket issued by other server. Because the server is familiar with a right detail of each user, a right data structure for managing the right detail and its management method, etc., it can realize diversified backup-restoration methods according to various situations such as a method to hold the right for backup and a method to restore the right held as a backup. Moreover, because of this, there is an effect to enhance a security level of the backup-restoration process.

In order to solve above issues, other backup-restoration system of the present invention comprises the terminal device further including a restoration request unit operable to request the server device to restore the backed-up usage right, and the server device further including: a terminal information memory unit operable to memorize terminal information indicating the terminal device owned by each user; a readout unit operable to specify the user of the terminal device sending the restoration request based on the terminal information, and read out the right information generated for the specified user from the backup unit; and a restoration unit operable to generate the license ticket indicating the readout right information, and issue the license ticket to the terminal device sending the restoration request.

Therefore, with the backup-restoration system of the present invention, even if the terminal executing the backup is broken, the backup data can be easily restored by a restoration request from other terminal owned by the same user.

### BRIEF DESCRIPTION OF DRAWINGS

FIG. 1 is a block diagram that shows a structure of the content distribution system according to the first embodiment.

FIG. 2 is a communication sequence diagram that shows communication procedures between the right management server and the terminal for an LT issuance request from a terminal indicated in FIG. 1.

FIG. 3 is a diagram to show an LT data structure generated in an LT generation process in FIG. 2.

FIG. 4 is a communication sequence diagram that shows communication procedures between the right management server and the terminal for a backup request from the terminal indicated in FIG. 1.

FIG. 5 is a data structure diagram of the backup management table managed by the right data management unit indicated in FIG. 1.

FIG. 6 is a communication sequence diagram that shows communication procedures between the right management server and the terminal for a restoration request from the terminal indicated in FIG. 1.

FIG. 7 is a block diagram to show a structure of the content distribution system according to the second embodiment.

FIG. 8 is a data structure diagram of user information managed by the user information management unit in the user information DB in FIG. 7.

FIG. 9 is a communication sequence diagram that shows communication procedures between the right management server and the terminal for a terminal registration request from the terminal indicated in FIG. 7.

FIG. 10 is a data structure diagram of right information managed by the right data management unit in the right information DB in FIG. 7.

FIG. 11 is a communication sequence diagram that shows communication procedures between the right management server and the terminal for the LT issuance request from the terminal indicated in FIG. 7.

FIG. 12 is an LT data structure diagram generated in the LT generation process in FIG. 11.

FIG. 13 is a communication sequence diagram that shows communication procedures between the right management server and the terminal for a backup request from the terminal indicated in FIG. 7.

FIG. 14 is a sample table of a fluctuation in the number of the right affected by backup and restoration, which is respectively managed in the right management server and two terminals.

FIG. 15 is a data structure diagram of backup data managed by the right data management unit in the backup DB indicated in FIG. 7.

FIG. 16 is a communication sequence diagram that shows communication procedures between the right management server and the terminal for a restoration request from the terminal indicated in FIG. 7.

FIG. 17 is a block diagram to show a structure of the content distribution system according to the third embodiment.

FIG. 18 is a data structure diagram of the right information and the backup management table held in the right information DB indicated in FIG. 17.

FIG. 19 is a communication sequence diagram that shows communication procedures between the right management server and the terminal for the backup and restoration requests from the terminal indicated in FIG. 17.

FIG. 20 is a sample table of a fluctuation in the number of the right affected by backup and restoration, which is respectively managed by the right management server and two terminals.

FIG. 21 is a block diagram to show a structure of the content distribution system according to the fourth embodiment.

FIG. 22 is a sample table of a fluctuation in the number of the right affected by backup and restoration, which is respectively managed by the right management server and two terminals.

FIG. 23 is a communication sequence diagram that shows communication procedures between the right management server and two terminals for a backup request from the terminal indicated in FIG. 21.

FIG. 24 is a communication sequence diagram that shows communication procedures between the right management server and two terminals for a restoration request from the terminal indicated in FIG. 21.

FIG. 25 is a diagram to show a specific example for a case a number of times for the restoration executed by each user is recorded in the user information DB indicated in FIG. 21, and restoration permission is controlled within a certain scope.

FIG. 26 is a diagram to show a specific example for a case the backup process is controlled according to a backup permission flag added to the right data in the right information DB shown in FIG. 21.

FIG. 27 is a diagram to show an example of a backup request screen displayed on the terminal.

### BEST MODE FOR CARRYING OUT THE INVENTION

(The First Embodiment)

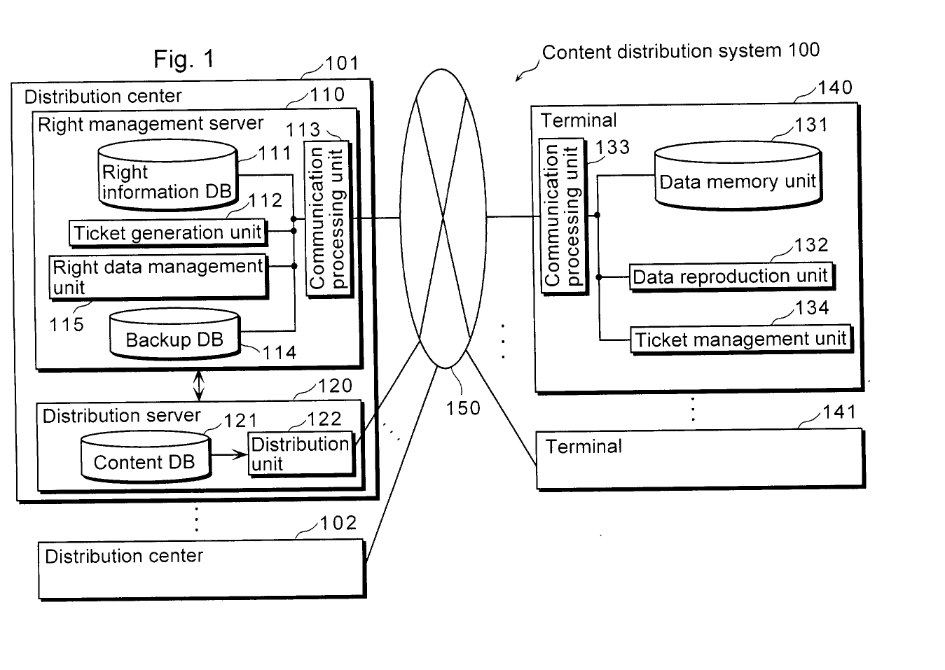

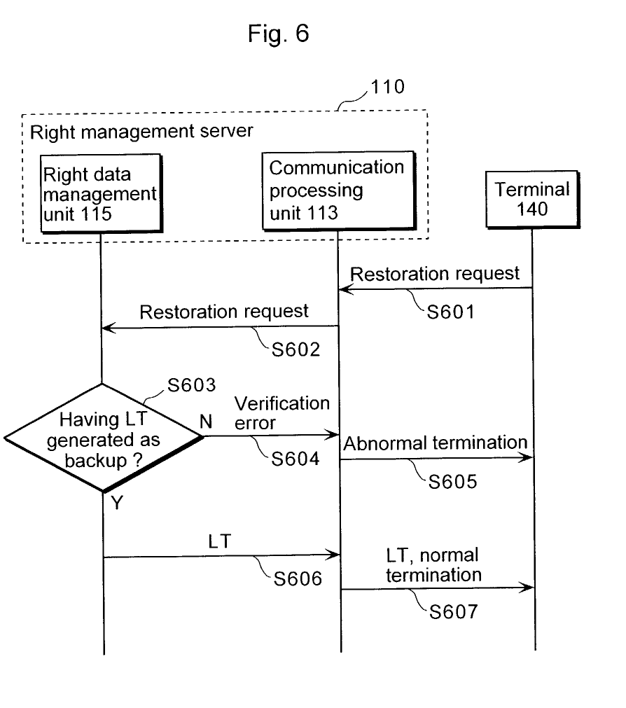

The following is an explanation of the first embodiment of the present invention with reference to FIG. 1˜FIG. 6. FIG. 1 is a block diagram to show a structure of a content distribution system 100 according to the first embodiment. The content distribution system 100 according to this embodiment is a communication distribution system that makes a distribution center centrally manage license usage authorization of content such as images, games and productions, and that makes a server side perform backup for a content usage right for each terminal, which consists of distribution centers 101˜102 and multiple terminals 140˜141 connected each other via a communication network 150.

The distribution centers 101˜102 distribute content to the user and issue a license ticket (hereinafter referred to as LT) that allows the user to use the content distributed according to a request from the user. This LT is issued in response to an LT issuance request from a user who subscribes content, which mainly consists of a content key that is for decrypting encryption of the content and a content usage rule that allows usage of the requested content under a specific condition within a range of content usage right that is subscribed by the user in advance. The distribution centers 101˜102 are equipped with a right management server 110 and a distribution server 120 that are connected each other. The right management server 110 is a server realized in a computer system, etc., which manages the content usage right subscribed by each user. The right management server 110 is equipped with 2 databases (hereinafter referred to as DB) (a right information DB 111 and a backup DB 114) realized by a hard disk, etc. and 3 processing units (a ticket generation unit 112, a communication processing unit 113 and a right data management unit 115) realized by a program, etc.

The right information DB 111 memorizes the subscribed content usage right by each terminal 140. The ticket generation unit 112 manages the subscribed content usage right by each terminal 140 and issues an LT based on the content usage right managed. To be more specific, it searches the right information DB 111 to check if the content usage right requested by the LT issuance request is already subscribed. If it is already subscribed, the usage for this time is subtracted from the content usage rule in the right information DB 111 and the LT is issued accordingly. The communication processing unit 113 receives the request from each terminal, sends it to the ticket generation unit 112, and then sends the LT received from the ticket generation unit 112 to the terminal 140 originating the request. The backup DB 114 is a memory area that holds right data (LT) related to a backup request from each terminal and a backup management table indicating a relation of the backup data to each terminal. The relation between the right data (LT) backed-up and the terminal 140 requesting to backup are described in the backup management table. The right data management unit 115 records the right data (LT) to the backup DB 114 by responding to the backup request from the terminal 140 as long as the right data (LT) related to the backup request is the one issued by itself in the past to the terminal 140. Otherwise, its abnormal termination of the process (i.e. not accepting the backup request) is reported to the terminal 140. Also, if there is backup data corresponding to a restoration request from the terminal 140 in the backup DB 114, the right data management unit 115 executes the restoration process based on the backup data.

The distribution server 120 is a server that distributes content to each terminal 140 and consists of a computer system, etc. that are equipped with a content DB 121 as a memory unit such as a hard disk and a distribution unit 122 realized by a program, etc. The content DB 121 memorizes various types of contents prepared in advance and a content key that is for decrypting encryption of the contents. These contents are respectively managed with a content ID. The distribution unit 122 reads out the content held in the content DB 121 according to a content distribution request from each terminal and encrypts the readout content with the content key and distributes it to a terminal 140 originating the request. The distribution server 120 reads out the content key within the content DB 121 according to a request of the right management server 110 and sends it to the right management server 110.

The terminals 140˜141 are a personal computer or an exclusive reproduction device for the content distribution system 100 that caters a program to reproduce the content distributed from the distribution server 120 according to the LT issued from the right management server 110. Each of the terminals 140˜141 contains a data memory unit 131, a data reproduction unit 132, a communication processing unit 133 and a ticket management unit 134, which are all tamper-resistant. The data memory area 131 is a memory unit to hold the content received from the distribution server 120 and the LT issued from the right management server 110, which is realized by a hard disk or a tamper-resistant IC card. The data reproduction unit 132 precisely reproduces the content received from the distribution server 120 or the content held in the data memory unit 131 according to the LT issued. The communication processing unit 133 sends various requests such as an LT issuance request, a backup request, a restoration request and a content distribution request to the distribution center 101, then respectively transfers the content received from the distribution center 101 to the data reproduction unit 132 and the received LT to the ticket management unit 134. The ticket management unit 134 creates various requests such as the LT issuance request, the backup request, the restoration request and the content distribution request. And, it also stores and manages the LT received from the right management server 110 in the data memory unit 131.

The communication network 150 is a communication network such as the Internet using an optical fiber like FTTH (Fiber To The Home) as a high-speed transmission line. The communication network 150 transmits the LT according to a secure communication protocol such as SSL (Secure Sockets Layer protocol) and SAC (Secure Authenticated Channel) on the Internet. The communication network 150 in the content distribution system 100 of the present invention is not limited to such as using the optical fiber like FTTH. It may be a communication network that can send and receive electric data such as using a communication cable and satellite broadcasting.

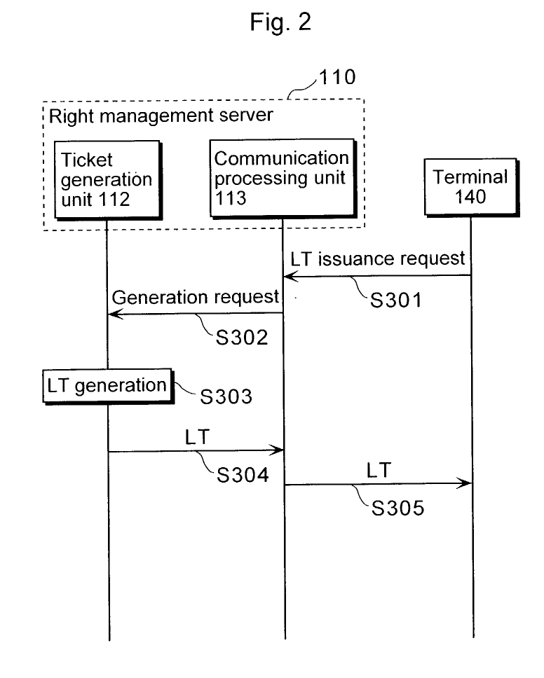

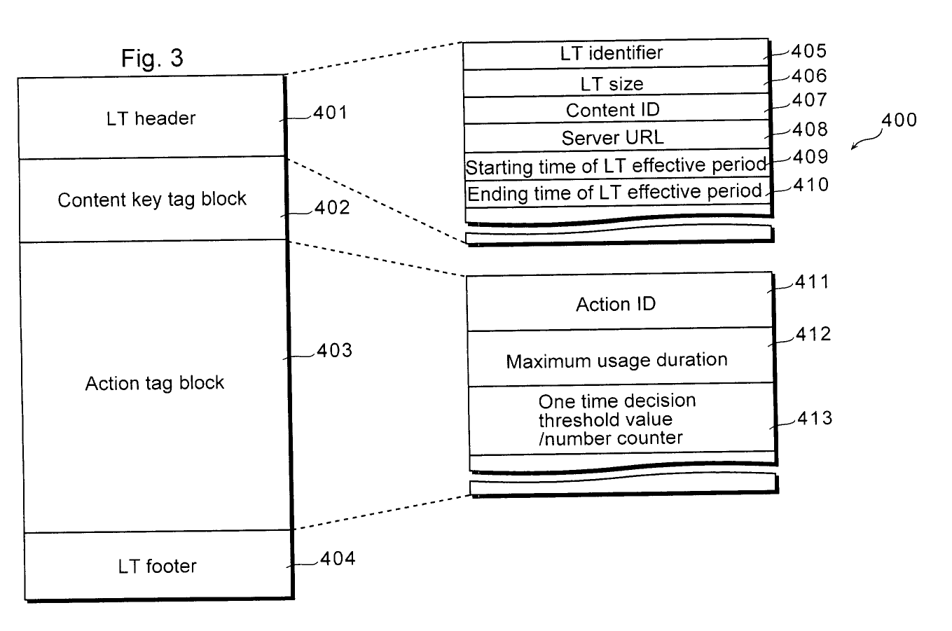

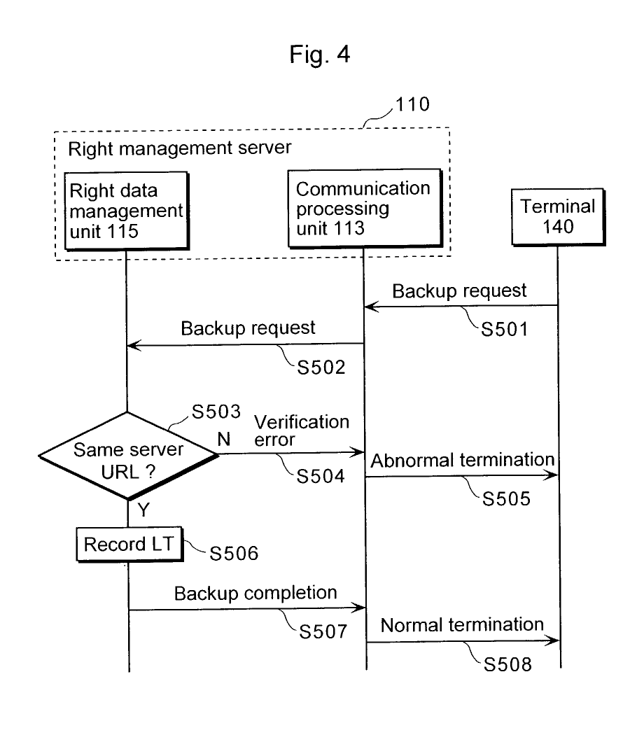

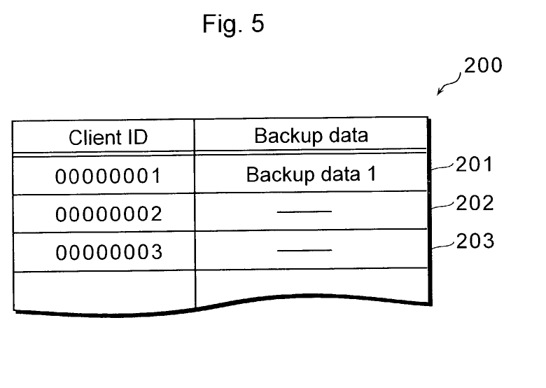

In the content distribution system 100 structured as above, actions of the right management server 110 and each terminal 140 in the process of backup and restoration of LT are explained as follows with reference to communication sequence diagrams in FIG. 2, FIG. 4 and FIG. 6 and data structure diagrams in FIG. 3 and FIG. 5.

Even if the user subscribes the right and receives the content distribution, he is not yet allowed to use the content. The LT must be issued for the user to use the content. Therefore, the user makes a request to issue the LT to the right management server 110 by operating the terminal 140. FIG. 2 is a communication sequence diagram that shows communication procedures between the right management server 110 and the terminal 140 for the LT issuance request made from the terminal 140 shown in FIG. 1. According to the user's operation, the terminal 140 sends the LT issuance request to the right management server 110 (S301). If the communication processing unit 113 on the right management server 110 receives the LT issuance request, it sends the issuance request of the relevant LT to the ticket generation unit 112 (S302). When the ticket generation unit 112 receives the issuance request, it confirms whether the subscribed content usage right corresponding to the terminal 140 making the request is held in the right information DB 110 or not. If it is held, the relevant LT is generated based on the content usage right (S303) and the generated LT is sent to the communication processing unit 113 (S304). Information to specify the right management server 110 as its issuer is added to this LT. When the communication processing unit 113 receives the LT, it sends the received LT to the terminal 140 (S305). Although it is not especially explained here, the user authentication or a billing process may be executed in the right management server 110 if needed.

FIG. 3 is a data structure diagram of an LT 400 that is generated in the LT generation process (S303) in FIG. 2. The LT 400 consists of each block of an LT header 401, a content key tag block 402, an action tag block 403 and an LT footer 404. The LT header 401 is an item to record bibliographic data of the entire LT, which consists of further detailed items such as an LT identifier 405, an LT size 406, a content ID 407, server URL (Uniform Resource Locator) 408, starting time of LT effective period 409 and ending time of LT effective period 410. The LT identifier 405 is an item to show this data is the LT in this content distribution system 100 and describes, for example, “NDRM” in ISO646 for every LT 400 issued by the right management server 110. The LT size 406 describes data size of this entire LT 400. The content ID 407 describes the content ID of the content associated with this LT 400. The LT 400 allows to use the contents only described in the content ID 407. The server URL 408 describes the URL of the right management server 110 that is the issuer of this LT 400. By reading the item in this server URL 408, the right management server 110 can identify whether this LT 400 is issued or not by the server. UTC(Coordinated Universal Time) is used to describe date and time in the staring time of LT effective period 409 when LT becomes effective and date and time in the ending time of LT effective period 410 when the LT is nullified.

Each LT 400 must always have only one content key tag block 402 that contains a decryption key for decrypting encryption of the content specified by the content ID 407 in the LT header 401. Each LT 400 must always have at least one action tag block 403 that consists of further detailed items such as an action ID 411, maximum usage duration 412 and one time decision threshold value/number counter 413. The action ID 411 describes an action ID that specifies an action as operational details for the content. As an example of the action, if the content is data to express images and sounds like a video, etc., there are actions such as ‘View’ to output sounds from a speaker and ‘Print’ to make a printer of the terminal 140 print the image data displayed on a liquid crystal display panel, etc., with the image data displayed on the liquid crystal display panel on the terminal 140. The action ID is an ID that uniquely specifies such actions. The maximum usage duration 412 describes the maximum time duration that allows to operate the content consecutively according to the aforementioned ID. In the one time decision threshold value/number counter 413, the time that decides the content is operated once is described in the one time decision threshold value, and the maximum number of times that allows to operate the content is described in the number counter. The LT footer 404 describes a hash value from the beginning of the LT 400 to a part just before the LT footer 404. The right management server 110 and the terminals 140˜141 can detect whether the received LT 400 is altered or not by comparing the hash value described in the LT footer 404 with the hash value getting from the beginning of the received LT 400 to the part just before the LT footer 404. In the way just described here, the ticket generation unit 112 writes URL for the right management server 110 to the LT 400 corresponding to the LT issuance request and generates the LT to be sent.

The terminal 140 is not allowed to reproduce the content until it receives LT 400 generated in such a data structure, therefore this LT 400 can be considered as a valuable data for the user who subscribes the content. In order to prevent such a valuable data for the user from being deleted due to a breakdown of the terminal 140, etc., the right management server 110 provides a service to perform backup for the right in the backup DB 114, which is indicated in the LT 400 held in each terminal 140 by the user. FIG. 4 is a communication sequence diagram that shows communication procedures between the right management server 110 and the terminal 140 for a backup request from the terminal 140 indicated in FIG. 1. To make the right management server 110 perform backup for such an LT, the user operates the terminal 140 to send the backup request that is a command to request a backup, the client ID of the terminal 140 and the LT that is right data for backup are sent to the right management server 110 (S501). The client ID is unique identification information assigned by each terminal 140 when the terminal 140 is manufactured. When the communication processing unit 113 of the right management server 110 receives the backup request, it sends the backup request, the client ID of the terminal 140 received from the terminal 140 and the LT for backup to the right data management unit 115 (S502). If the right data management unit 115 receives the backup request, it judges whether or not the server URL in the received data (LT) for backup is identical to its URL (S503). If the URL is not identical, the right data management unit 115 sends a judgement error message to the communication processing unit 113 (S504), then the communication processing unit 113 receiving it sends an abnormal termination message to the terminal 140 (S505). If the URL is identical, the right data management unit 115 records the data for backup to the backup DB 114, and records the relation between the data for backup and the client ID to the backup management table 200 (S506), and then sends a backup completion message to the communication processing unit 113 (S507). When the communication processing unit 113 receives the backup completion message, it sends the backup completion message to the terminal 140 (S508). In the way described here, because the right data management unit 115 confirms the terminal 140 with the server URL written in the LT for backup, it does not especially require to conduct user authentication by the user ID nor the password when backup is requested.

FIG. 5 shows a data structure of the backup management table 200 managed by the right data management unit 115 shown in FIG. 1. The right data management unit 115 records the data for backup to the backup DB 114, and writes the relation between the data (LT) backed-up and the terminal 140 requesting the backup to the backup management table 200. To be specific, a combination of the client ID as unique identification information by each terminal 140 and the backup data for the data (LT) of each terminal 140 managed in the backup management table 200.

In the backup management table 200, the combination 201 of the client ID “00000001” and the backup data “backup data 1”, the combination 202 of the client ID “00000002” and “no backup data”, and the combination 203 of the client ID “00000003” and “no backup data” are being recorded. It shows that the data “backup data 1” backed-up from the terminal 140 specified by the client ID “00000001” is held in the backup DB 114. Also it shows there is no backed-up data from the terminal 140 with the client ID “00000002” and the terminal 140 with the client ID “00000003”. The “backup data” in the backup management table 200 in FIG. 5 does not have to be the data itself that is subject for backup, and it may be the information that can uniquely identify the backed-up data such as a data identifier of the backed-up data, or the address for a storage location within the backup DB 114.

In order to restore the right data backed-up in the right management server 110 to each terminal 140, the terminal 140 needs to make a restoration request to the right management server 110. FIG. 6 is a communication sequence diagram that shows communication procedures between the right management server 110 and the terminal 140 for the restoration request made from the terminal 140 shown in FIG. 1. The terminal 140 sends the restoration request and the client ID of the terminal 140 to the right management 110 (S601). If the terminal 140 is broken and the backup data requested by the terminal 140 should be restored from other terminal 141, the terminal 141 may acquire the client ID of the terminal 140 in some method and send the acquired client ID of the terminal 140 as its substitute. For example, as a method for the user to acquire the client ID of the terminal 140, the terminal 140 may readout its client ID from a specific memory area in the terminal 140 and display it on its backup request screen to notify it to the user. Or the user may apply for a use of the terminal 141 as a substitute of the terminal 140 to the right management server and register its client ID in advance. Also, the client ID can be written on an instruction sheet, etc. that is packed with the terminals 140˜141 when they are shipped.

When the communication processing unit 113 on the right management server 110 receives the restoration request, it sends the restoration request and the received client ID to the right data management unit 115 (S602). When the right data management unit 115 receives the restoration request, it judges whether or not the backup data relevant to the received client ID is recorded to the backup DB 114 by searching the backup management table 200 (S603). If it is not recorded, the right data management unit 115 sends a judgement error message to the communication processing unit 113 (S604), and the communication processing unit 113 receiving this sends an abnormal termination message to the terminal 140 (S605). Also, if it is recorded the right data management unit 115 reads out the backup data from the backup DB 114 and sends it to the communication processing unit 113 (S606). When the communication processing unit 113 receives the data, it sends the received data to the terminal 140 (S607).

In the above embodiment, an explanation is provided with reference to a license ticket as an example of the data for backup in the content distribution system 100. However, the data for backup in the present invention is not limited to this. It may be any kind of data as long as it is the data distributed from a server to each terminal.

Although URL of the right management server 110 is used here as information to specify the right management server 110, it is not limited to this. It may be any kind of information as long as the information can specify the right management server 110. In order to protect such additional information like URL of the right management server 110, the additional information can be encrypted by a public key stored in the terminal 140. For example, this can be realized by storing the public key in the terminal 140, which corresponds to a private key held in the right management server 110, when the terminal 140 is shipped.

According to the explanation of this embodiment, thought the distribution centers 101˜102 contain the right management server 110 and the distribution server 120 within each distribution centers 101˜102, the distribution centers 101˜102 don't need to contain both servers. In short, the content distribution and the right management may be handled independently each other. To be more specific, the content distribution may be executed independently by the distribution center 101 containing the distribution server 120, while another distribution center 102 may contain the right management servers 110˜102 to execute right management only.

Also, according to the explanation of this embodiment, the distribution server 120, which manages the content and the content key, sends the encrypted content and the content key to both of the terminal 140 and the right management server 110. However, it is not limited to this. Other server different from the right management server 110 and the distribution server 120 may encrypt the content, and send the content key used for the encryption to the right management server 110 and the encrypted content to the distribution server 120.

(The Second Embodiment)

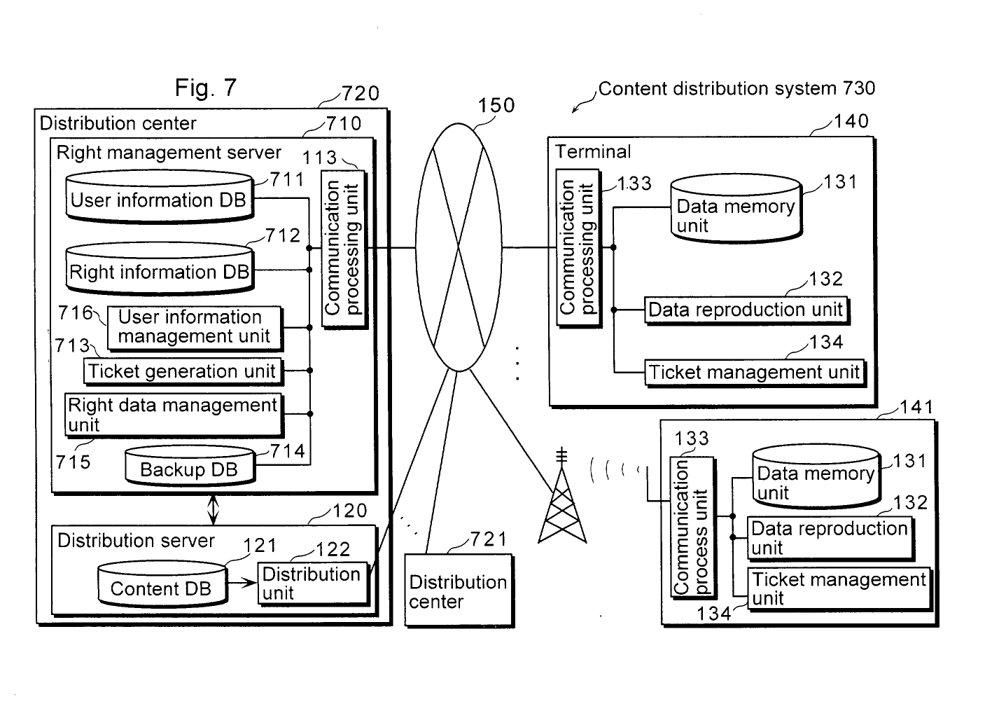

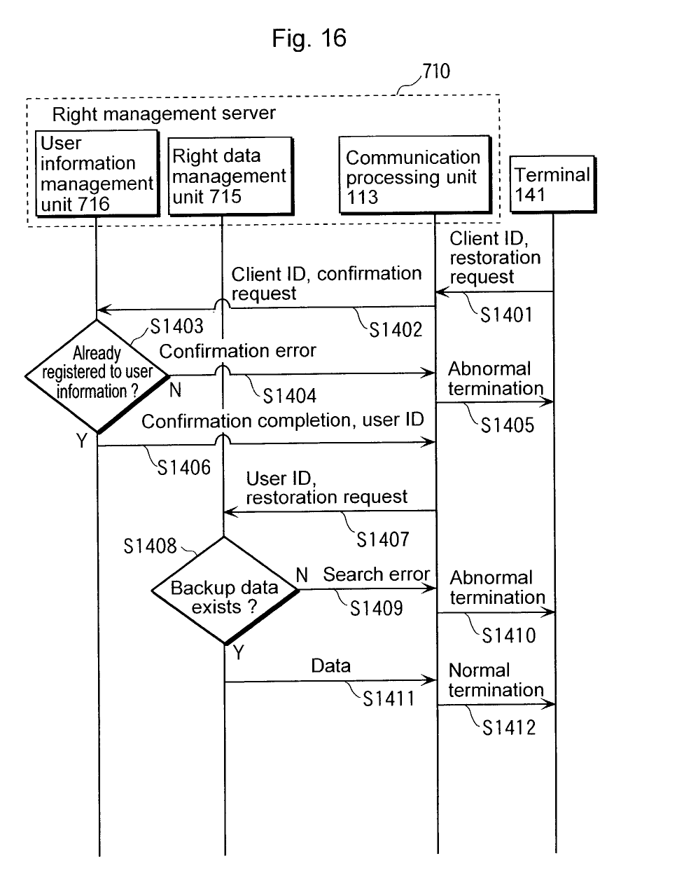

The second embodiment is explained as follows with reference to FIG. 7˜FIG. 16. FIG. 7 is a block diagram to show a structure of a content distribution system 730 in the second embodiment. The same reference numbers are used to the same structure components as those used in the content distribution system 100 of the first embodiment; therefore, explanations for those are omitted. Regarding a point the content distribution system 730 is different from the content distribution system 100 shown in FIG. 1, the right management server 710 manages the subscribed right and the right data related to a backup request from the terminals 140˜141 based on each user. The content distribution system 730 is composed of multiple distribution centers 720˜721 and multiple terminals 140˜141 that are connected each other via the communication network 150. The terminal 141 is a mobile phone, etc. connected to the distribution center 720 via a mobile telephone communication network, which is equipped with the communication processing unit 133 executing a wireless communication with a relay station in the mobile telephone communication network. The distribution center 720 is equipped with the right management server 710 and the distribution server 120.

The right management server 710 is composed of 3 memory units consisting of a hard disk, etc. (a user information DB 711, a right information DB 712 and a backup DB 714) and 4 processing units realized by a program, etc. (a ticket generation unit 713, a right data management unit 715, a user information management unit 716 and a communication processing unit 113). The user information DB 711 memorizes personal information of the user who resisters to the right management server 710 and the client ID of the terminal 140 used by the user. The right information DB 712 memorizes the content usage right subscribed by the user on a user basis. The ticket generation unit 713 issues the LT based on the content usage right managed within the right information DB 712. The backup DB 714 is a memory area to hold the content usage right (LT) related to a backup request of each user. The right data management unit 715 manages the subscribed content usage right on a user basis in the right information DB 712. And, according to a user's request, it performs backup for the content usage right (LT) that the user manages in each terminals 140˜141, and restores it. To be more specific, after the user whose terminal 140 is making the backup request is confirmed to be a pre-registered user, the right data management unit 715 associates the right (LT) related to each user's backup request with the user ID of the user, stores them to the backup DB 714 and manages these relations in a table. Also, according to the user's restoration request, the content usage right (LT) that is backed-up in the backup DB 714 is restored in the user terminals 140˜141. The user information management unit 716 relates the client ID to the user ID, stores them in the user information DB 711, and manages the stored user information.

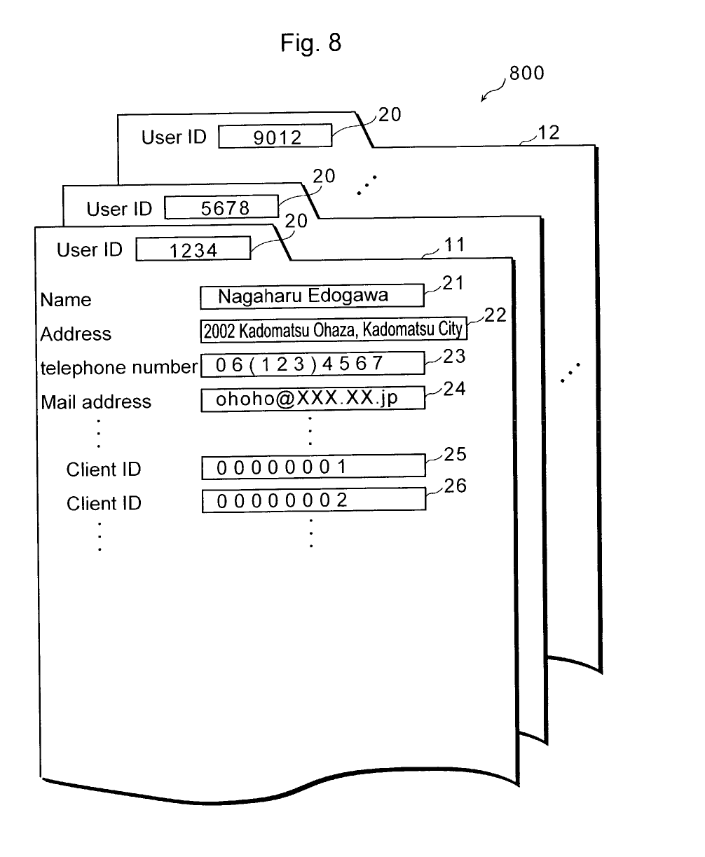

FIG. 8 is a diagram to show a data structure of user information 800 managed by the user information management unit 716 in the user information DB 711 in FIG. 7. The user information 800 consists of user information 11˜12 for each user who registers to the distribution center 720. This user information 11˜12 is managed by the user ID 20 assigned to the user when he is registered to the distribution center 720. In the user information 11˜12 specified by this user ID 20, personal information regarding individual user and terminal information regarding the terminal 140 used by the user are described. As the personal information, a user's name 21, an address 22, a telephone number 23 and an e-mail address, etc. are described. As the terminal information, client IDs 25˜26 of the terminal 140 used by the user are described.

For example, the personal information of the user information 11 describes “Nagaharu Edogawa” as the user's name, “2002 Ohaza Kadomatsu, Kadomatsu city” as the address 22, “06(123) 4567” as the telephone number 23, and “ohoho@xxx.xx.jp” as the e-mail address 24 specified by the user ID 20 “1234”. Additionally, the terminal information of the user information 11 describes that the user specified by the user ID 20 “1234” uses the terminal 140 of which client ID 25 is “00000001” and the terminal 141 of which client ID 26 is “00000002”. The user information management unit 716 manages a combination of the user ID and the client ID according to this terminal information.

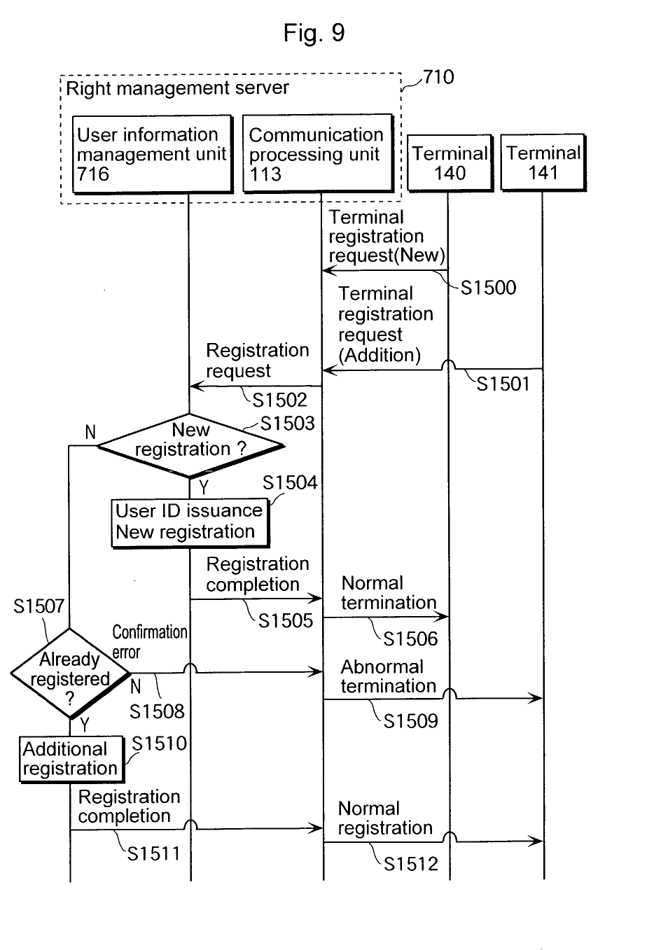

FIG. 9 is a communication sequence diagram that shows communication procedures between the right management server 710 and the terminals 140˜141 for a terminal registration request from the terminals 140˜141 shown in FIG. 7. Along with it, the explanation is given with reference to a case the user “Nagaharu Edogawa” newly registers the terminal 140 (TV unit) to use the content in the content distribution system 730 shown in FIG. 8.

When the user newly registers the terminal 140 to the right management server 710, the terminal 140 sends a terminal registration request and the client ID of the terminal 140 to the right management server 710 (S1500). To be specific, the user “Nagaharu Edogawa” operates the terminal through a remote controller, etc. in accordance with instructions on a menu screen indicated on the terminal 140 and conducts a procedure for the new registration. In this case, personal information such as the user's name 21, the address 22, the telephone number 23 and the e-mail address 24 is entered on the screen (new registration screen) displayed for the procedure of the new registration. When the user “Nagaharu Edogawa” completes his input of the said entry items and presses a sending button displayed on the new registration screen, the terminal 140 forms a terminal registration request with an attachment of the entered personal information, reads out the client ID “00000001” of the terminal 140 memorized internally and attaches it to the request, and then sends it to the right management server 710.

Also, if the user newly purchases and registers the terminal 141 in addition to the registered terminal 140, there are two methods available for its registration. One is to register the terminal 141 directly from the terminal 141. Another is to register the terminal 141 as an addition from the terminal 140 already registered. In either of the cases, a terminal registration request as a command, the client ID of the terminal 141 not yet registered and the client ID of the terminal 140 already registered are sent from the terminals 140˜141 to the right management server 710 (S1501).

For example, if the user “Nagaharu Edogawa” who already has the terminal 140 (TV unit) registered newly purchases the terminal 141 (mobile telephone) and makes an additional registration for the terminal 141 directly from the terminal 141, the user “Nagaharu Edogawa” conducts a procedure for the additional registration by operating the ten key, etc. in the terminal 141 (mobile telephone) according to instructions on a menu screen displayed on the terminal 141 (mobile telephone) screen. In this case, on the screen (additional registration screen) where the procedure for the additional registration is displayed, the client ID 25 “00000001” of the terminal 140 (TV unit) already registered is entered. This client ID 25 “00000001” may be displayed on a display screen to the user when the new registration of the terminal 140 is normally completed, or may be written on the instruction sheet enclosed in the package of the terminal 140. Also, it is possible that the client ID 25 “00000001” is written on an IC card enclosed in the package of the terminal 140 so that the client ID 25 “00000001” can be available by reading out from other terminal 141 if the terminal 140 is broken, etc. By such a way, when the user “Nagaharu Edogawa” completes its entry and presses a sending button, etc displayed on the additional registration screen, the terminal 141 generates the terminal registration request containing the client ID 25 “00000001” of the terminal 140 already registered, and reads out the client ID “00000002” of the terminal 141 internally memorized, attaches it to the terminal registration request, and then sends it to the right management server 710.

When the communication processing unit 113 on the right management server 710 receives the terminal registration request, the received client ID and the registration request in the case of new registration, or the received two client IDs and the registration request in the case of additional registration are sent to the user information management unit 716 (S1502). When the user information management unit 716 receives the registration request, it decides by the number of the received client ID whether it is for the new registration or additional registration (S1503). Here, if it is decided to be the new registration, a new user ID 20 is issued, and the issued user ID 20 and the received client ID are related and recorded to the user information DB 711 (S1504). For example, if the user “Nagaharu Edogawa” makes a new registration in the step S1500, the user information management unit 716 newly issues the user ID 20 “1234” to the user “Nagaharu Edogawa”, generates the user information 11 along with a linkage among the issued user ID 20 “1234”, the received personal information and the client ID 25 “00000001” for the user “Nagaharu Edogawa”, and records it to the user information DB 711. After it is recorded, the user information management unit 716 sends a registration completion message to the communication processing unit 113 (S1505), and the communication processing unit 113 sends a normal termination message to the terminal 140 (S1506). Accordingly, the terminal 140 displays messages that the new registration of the terminal 140 is normally completed and that the client ID 25 of the registered terminal 140 is “00000001” on the display screen.

If it is decided to be the additional registration, the user information management unit 716 confirms whether the received client ID registered is surely the one registered to the user information DB 711 or not (S1507). The user information management unit 716 searches the user information DB 711, for example, by using the registered client ID 25 “00000001” as a key. If its registration is not confirmed here, the user information management unit 716 sends a confirmation error to the communication processing unit 113 (S1508), and the communication processing unit 113 sends an abnormal termination message to the terminal 141 (S1509). If its registration is confirmed, the user ID 20 is related to the client ID for the additionally registered terminal and recorded to the user information DB 711 (S1510). For example, the client ID 26 “00000002” of the additionally registered terminal is added to the user information 11 related to the user ID 20 “1234”. After it is registered, the user information management unit 716 sends the registration completion message to the communication processing unit 113 (S1511), and then the communication processing unit 113 sends the normal termination message to the terminal 141 (S1512). Accordingly, the terminal 141 displays the messages that the additional registration of the terminal 141 is normally terminated and that the client ID 26 of the registered terminal 141 is “00000002” on its display screen.

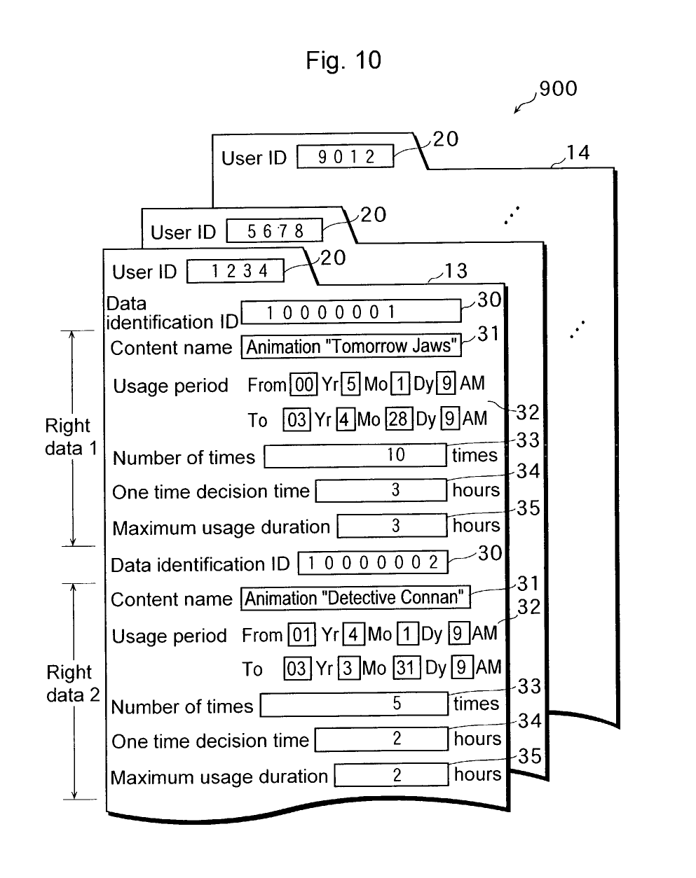

FIG. 10 is a diagram to show a data structure of right information 900 managed by the right data management unit 715 in the right information DB 712 in FIG. 7. The right information 900 consists of the right information 13˜14 that indicates right details currently owned by each user who subscribes the content usage right. The right information 13˜14 is managed by the user ID 20 of each user. The right information 13˜14 specified by the user ID 20 describes the right data indicating the right details (content usage right) owned by the user. This right data is described, for example, based on one content as its unit, and the data identification ID 30 that specifies the right data is assigned to each right data. For example, in the right information 13 for the user whose user ID 20 is “1234”, the “right data 1” with the data identification ID “10000001” and the “right data 2” with the data identification ID “10000002” are described.

Each right data is composed of a content name ID 31, a usage period 32, a number of times 33, one time decision time 34 and the maximum usage duration 35. The content name 31 is data to show which content can be used with this right. The usage period 32 is data to show starting time and ending time of the effective period that allows to use the content with this right. The number of times 33 shows how many times the content can be used with this right, and the one time decision time 34 shows the time length to count the content is used once. The maximum usage duration 35 shows the maximum time duration that allows to use the content consecutively. For example, the “right data 1” shows that this right is the right to use an animation called “Tomorrow Jaws”, the effective period of this right is from “2000/5/1, 9 a.m.” to “2003/4/28, 9 a.m.”, its usage for “3” hours is counted as once, and the right allows to use the content “10” times. If the animation “Tomorrow Jaws” is used with this right, it also describes the content can be consecutively used up to “3” hours. Also, the “right data 2” describes this right is the right to use an animation called “Detective Connan”, the effective period of this right is from “2001/4/1, 9 a.m.” to “2003/3/31, 9 a.m.”, its usage for “2” hours is counted as once and the right allows to use the content “5” times. If the animation “Detective Connan” is used with this right, it also describes that it can be consecutively used up to “2” hours.

Every time the ticket generation unit 713 issues the LT, a portion used is subtracted from the above-mentioned right data, and eventually the right subscribed will have zero in its usage balance. Even in that case, the right data management unit 715 does not immediately delete the right data and holds at least the data identification ID of the right data and its final value. For example, it holds “0 times” in the right information DB 712 as its history for a certain period of time or within the effective period of the LT. By doing so, the right management server 710 can correspond to a backup request from the terminals 140˜141 within a period to hold the historical right data even after the balance of the right data managed per each user in the right management server 710 becomes zero.

Although the explanation is given based on a premise that all of the data to show the right details are described in each right data such as the “right data 1” and the “right data 2”, the present invention is not only limited to this example. For the right to use the same content such as “Tomorrow Jaws”, if usage rules such as the usage duration 32, the one time decision time 34 and the maximum usage duration 35 are in common, these can be held in other memory area and only the content name 31 and the number of times 33 can be described in the right information 13˜14. Also, if the right to use a specific content is defined, for example, if the data identification ID of the right to use the animation “Tomorrow Jaws” is defined to be a specific value like “10000001”, the content name 31 can also be omitted and the data identification ID “10000001” and the number of times 33 can only be described in each user's right information 13˜14.

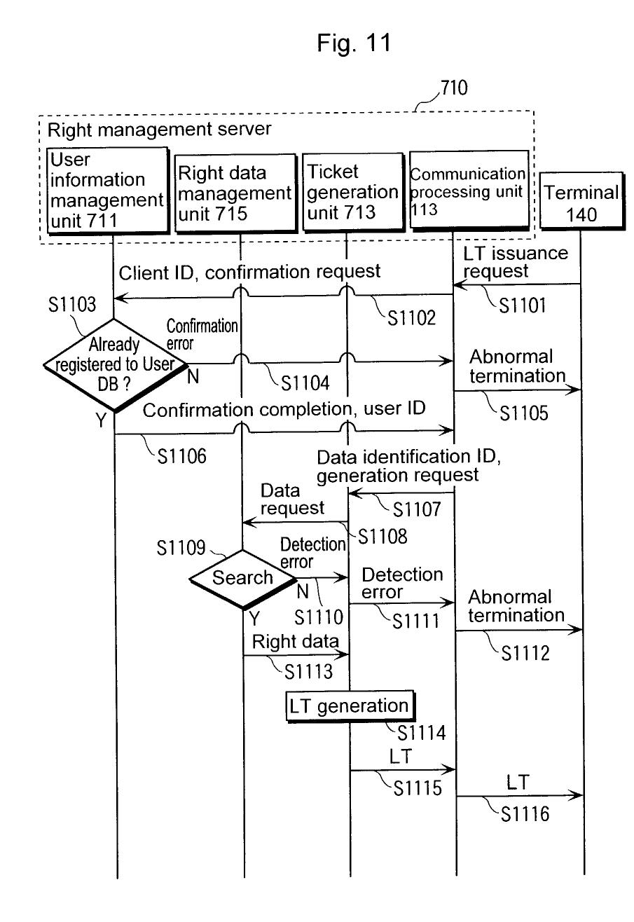

FIG. 11 is a communication sequence diagram that shows communication procedures between the right management server 710 and the terminal 140 for the LT issuance request from the terminal 140 shown in FIG. 7. Along with this, the explanation is provided with reference to an example the user “Nagaharu Edogawa” (User ID 20 “1234”), who owns the content usage right indicated in the right information 13 shown in FIG. 10, sends the right management server 710 the LT issuance request to use the animation “Tomorrow Jaws” 4 times. At first, the terminal 140 sends the client ID of the terminal 140, the data identification ID requested to be sent and the LT issuance request to the right management server 710 according to the user's input operation (S1101). To be specific, the user “Nagaharu Yodogawa” makes the LT issuance request by operating a remote controller, etc. according to instructions on the menu screen displayed on the terminal 140. In this case, on the screen displayed for the LT issuance request (LT issuance request screen), any necessary items such as the animation “Tomorrow Jaws” as a title of the content the user wants to use and “4 times” as the number of times to use (or usage duration) are selected and entered. As a result of this, the data identification 30 “10000001” in the right data 1 as the right to use the animation “Tomorrow Jaws” and “4 times” as the number of times to use are entered to the terminal 140. When the user “Nagaharu Edogawa” completes the entry and presses a sending button indicated on the LT issuance request screen, the terminal 140 generates LT issuance request data containing the entered data identification ID 30 “10000001” and “4 times” as the number of times to use. And it reads out the client ID “00000001” of the terminal 140 internally memorized, attaches it to the LT issuance request, and then sends it to the right management server 710.

When the communication processing unit 113 of the right management server 710 receives the LT issuance request, it sends the confirmation request and the received client ID “00000001” to the user information management 716 (S1102). When the user information management unit 716 receives the confirmation request, it confirms if the received client ID “00000001” is registered to the user information DB 711 (S1103). If its registration is not confirmed here, the user information management unit 716 sends a confirmation error to the communication processing unit 113 (S1104), and then the communication processing unit 113 sends an abnormal termination message to the terminal 140 (S1105). If its registration is confirmed, the user information management unit 716 sends a confirmation completion message and the user ID 20 corresponding to the client ID to the communication processing unit 113 (S1106). In this case, if the user information DB 711 is searched by the client ID “00000001” as a key, the user information 11 of which user ID 20 is “1234” is retrieved. By doing so, the registration of the terminal 140 of which client ID is “00000001” is confirmed so that the user information management unit 716 sends a confirmation completion message and the user ID 20 “1234” corresponding to the client ID “00000001” to the communication processing unit 113.

When the communication processing unit 113 receives the confirmation completion message, it sends the generation request, the received data identification ID 30 “10000001” and the user ID 20 “1234” to the ticket generation unit 713 (S1107). When the ticket generation unit 713 receives the generation request, it sends the data request, the received user ID 20 “1234” and the data identification ID 30 “10000001” to the right data management unit 715 (S1108). When the right data management unit 715 receives the data request, it searches the right information DB 712 to see if the right data of the data identification ID 30 “10000001” corresponding to the received user ID 20 “1234” exists (S1109). If the relevant data is not detected here, the right data management unit 715 sends a detection error to the ticket generation unit 713 (S1110), the ticket generation unit 713 sends the detection error to the communication processing unit 113 (S1111) and the communication processing unit 113 sends an abnormal termination message to the terminal 140 (S1112).

If the relevant data is detected, the right data management unit 715 sends the detected right data to the ticket generation unit 713 (S1113). For example, if the right information DB 712 is searched by the user ID 20 “1234” and the data identification ID 30 “10000001”, the right data 1 recorded to the right information 13 is detected. The right data management unit 715 reads out and sends the detected right data 1 to the ticket generation unit 713. When the ticket generation unit 713 receives the right data 1 from the right data management unit 715, it generates the LT for transmission based on the received right data 1 (S1114). To be specific, the ticket generation unit 713 generates the LT for transmission to use the animation “Tomorrow Jaws” “4 times” based on the right data 1 that allows to use the animation “Tomorrow Jaws” “10 times”. The right data management unit 715 decrements the usage of “Tomorrow Jaws” for “4 times” from the right data 1, and updates the right data 1 in the right information DB 712. Also, the ticket generation unit 713 sends the generated LT to the communication processing unit 113 after the LT is generated (S1115). When the communication processing unit 113 receives the LT from the ticket generation unit 713, it sends the received LT to the terminal 140 (S1116). According to this LT, the terminal 140 receiving the LT is allowed to use the animation “Tomorrow Jaws” “4 times” up to 3 hours as a maximum for each consecutive usage, which means for total 12 hours.

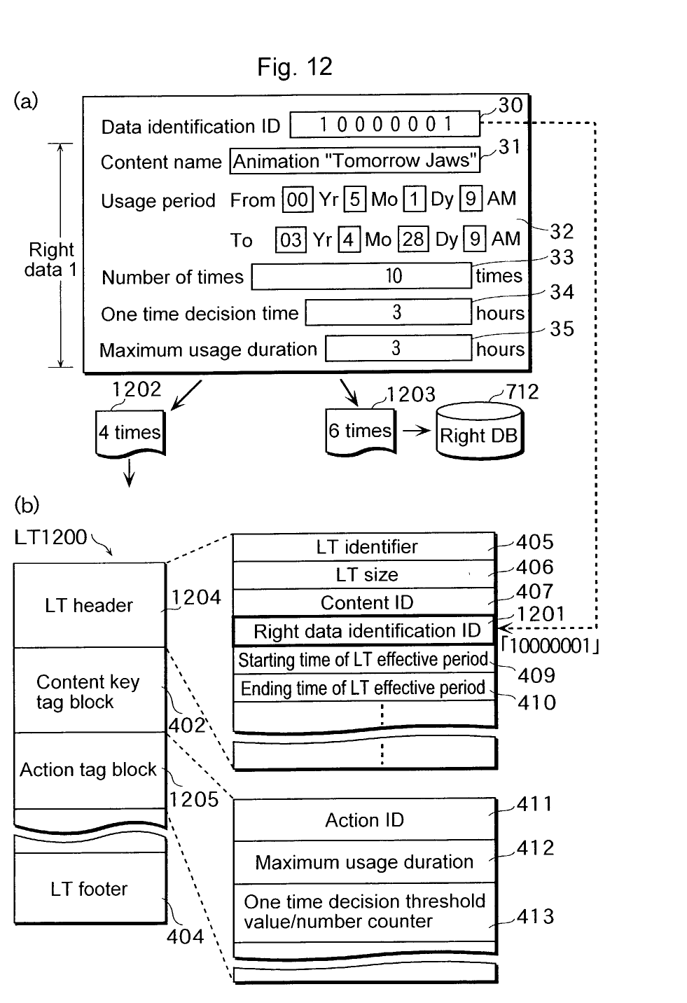

FIG. 12 is a diagram to show a data structure of the LT generated by the LT generation process (S1114) shown in FIG. 11. FIG. 12(a) is a diagram to show a specific example of the right data 1 shown in FIG. 10. FIG. 12(b) is a diagram to show a data structure of the LT 1200 generated based on the right data 1. Since their structure components same as those for LT 400 in FIG. 3 and for the right information 900 in FIG. 10 are already explained, the same reference numbers are assigned to them and their explanations are omitted. The right data 1 is the right data that specifies an entire scope of the right to use a specific content, the animation “Tomorrow Jaws” among the content usage rights owned by the user “Nagaharu Edogawa” indicated in the right information 13 of the right information 900 shown in FIG. 10. This right data 1 is readout by the right data management unit 715 from the right information DB 712 and sent to the ticket generation unit 713. Using this right data 1 as a basis, the ticket generation unit 713 generates the LT 1200 that allows to use the animation “Tomorrow Jaws” “4 times”. To be specific, at the time of LT generation, the ticket generation unit 713 combines the data identification ID 30 “10000001” of the right data 1 with the right data 1202 extracted from the right data 1 as a required part to use the content “4 times”, and generates the LT 1200 in FIG. 12(b) as the right data for transmission. The right data management unit 715 generates the right data 1203 that allows the usage for 6 times resulted by a decrement of the usage for 4 times of the right data 1202 from the readout right data 1, and updates the right data 1 in the right information DB 712 with the generated right data 1203.

As mentioned above, the LT 1200 generated by the ticket generation 713 is composed of an LT header 1204, a content key tag block 402, an action tag block 1205 and an LT footer 404. The LT header 1204 further consists of an LT identifier 405, an LT size 406, a content ID 407, a right data identification ID 1201, LT effectiveness starting time 409 and LT effectiveness ending time 410. In the right data identification ID 1201 of this LT 1200, “10000001” is written as the data identification ID 30 for the right data 1 managed by the right data management 715 of the right management server 710. By reading out the data identification ID 30 of this LT 1200, any of the right management server 710 and the terminals 140˜141 can specify the right management server 710 as an origin of the LT 1200 issuance. In the content ID 407, the content ID that specifies the same animation “Tomorrow Jaws” as the content name in the right data 1 is written. In the LT effectiveness starting time 409 and the LT effectiveness ending time 410, “2000/5/1, 9 a.m.” and “2003/4/28, 9 a.m.”, which are the same as those in the usage period 32 of the right data 1 are respectively written.

The action tag block 1205 of the LT 1200 corresponds to the right data 1202 that is an extraction as a necessary part to allow the user to use the animation “Tomorrow Jaws” 4 times. For example, in the action ID 411, the action ID that shows the action to reproduce the content (the animation “Tomorrow Jaws”) with moving images and sounds is written. In the maximum usage duration 412, “3 hours” same as the maximum usage duration 35 that is a usage rule of the right data 1 is written. In the item corresponding to the one time decision threshold value in the one time decision threshold value/number counter 413, “3 hours” same as the one time decision time 34 that is the usage rule of the right data 1 is written. However, in the item corresponding to the number counter of the one time decision threshold value/number counter 413, “4 times” is written to allow the usage only for 4 times.

Although the data identification ID 30 is used here as the combined additional information, it is not limited to this. It may be information that specifies to be the right information managed in the right management server 710. Also, to protect confidentiality of the additional information such as the data identification ID in the data memory unit 131 in the terminals 140˜141 or on a transmission path, these information can be encrypted by using a public key of the terminals 140˜141.

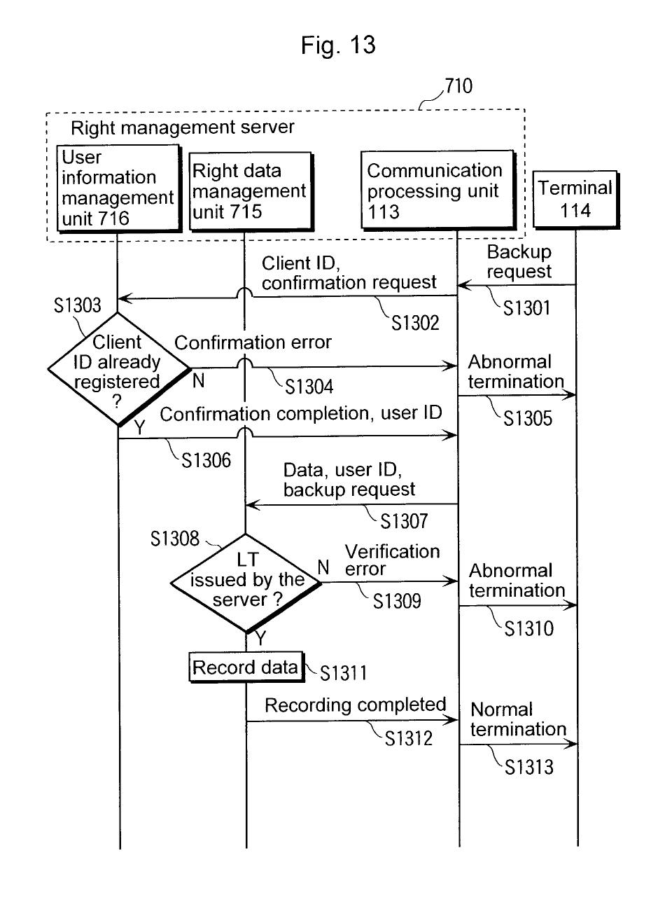

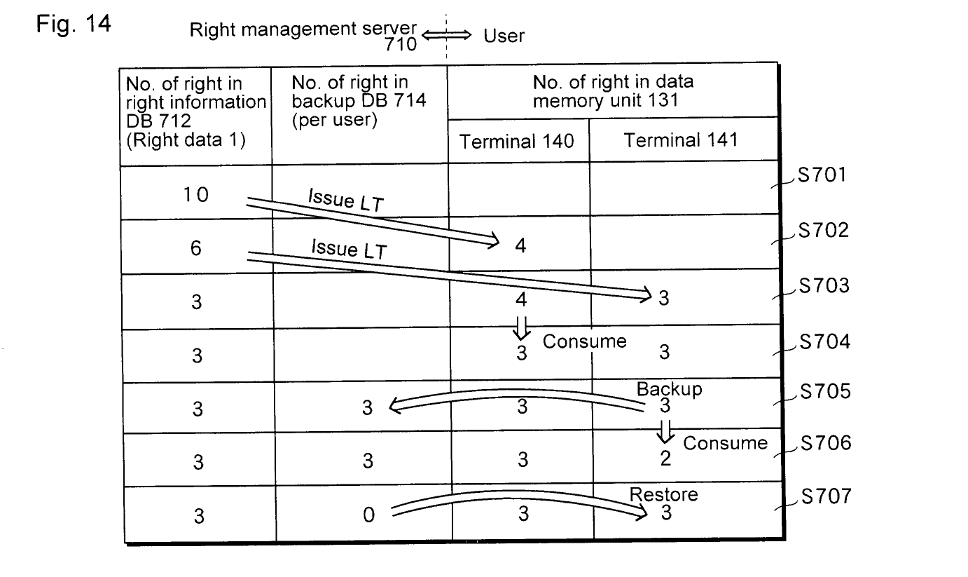

FIG. 13 is a communication sequence diagram that shows communication procedures between the right management server 710 and the terminal 141 for a backup request from the terminal 141 shown in FIG. 7. The explanation is provided with reference to a specific example that the user “Nagaharu Edogawa” (User ID 20 “1234”) who owns a content usage right shown in the right information 13 of FIG. 10 sends a backup request for the content usage right (LT) managed by the terminal 141 owned by him to the right management server 710. In this example, the terminal 140 and the terminal 141 are the terminals used by the same user “Nagaharu Edogawa”. The LT issued to the terminals 140 and 141 is for the usage through the generated LT which is extracted from the content usage right (right information 13) of the same user “Nagaharu Edogawa” managed in the right management server 710. To simplify the explanation, the number of rights is regarded to be the number of times to use a specific content, for example the number of times to use the animation “Tomorrow Jaws”. Along with it, with reference to FIG. 14, a fluctuation in the number of rights managed in the right management server 710, the terminals 140 and 141 is explained. FIG. 14 is a table to show a sample fluctuation in the number of rights affected by backup and restoration, which is respectively managed in the right management server 710 and terminals 140 and 141.

As shown in FIG. 14, it is supposed that the user “Nagaharu Edogawa” (user ID 20 “1234”) subscribes a right to use content, the animation “Tomorrow Jaws” for 10 times. The right subscribed by the user is stored as the right data 1 to which the data identification ID 30 “10000001” is assigned in the right information DB 712 of the right management server 710 (S701). At this point, the user merely holds the content usage right, and cannot actually reproduce nor use the content. Therefore, the user, for example, requests the right management server 710 to get an LT that allows to use the content, the animation “Tomorrow Jaws” for 4 times on the terminal 140. According to this LT issuance request, the LT that makes the animation “Tomorrow Jaws” be available to use 4 times is sent from the right management server 710 to the terminal 140. The terminal 140 stores and holds this LT in the data memory unit 131. By doing this, the user can reproduce the animation “Tomorrow Jaws” 4 times without making the terminal be online to the right management server 710. As a result of this, the content usage right for 4 times is moved to the terminal 140, and the remaining balance of the content usage right for the animation “Tomorrow Jaws” owned by the user “Nagaharu Edogawa”, which the right management server 710 manages as the right data 1 in the right information DB 712, is for 6 times (S702).

Next, since the user wants to use the content, the animation “Tomorrow Jaws” even in the terminal 141 that is a mobile phone, the user sends an issuance request for the LT corresponding to the content usage right for 3 times from the terminal 141. In this case, the LT that allows the usage for 3 times is issued from the right management server 710 to the terminal 141 and the remaining balance of the right data 1 managed in the right management server 710 becomes for 3 times (S703). Subsequently if the user uses the content once in the terminal 140, the right held on the terminal 140 is spent for its usage and remains to be for 3 times (S704).

At this point, it is presumed that the terminal 141 makes a backup request for the content usage right managed by the data memory unit 131. To be specific, the terminal 141 sends the backup request, the client ID “00000002” of the terminal 141 and the right data (LT) for 3 times for backup to the right management server 710 (S1301 in FIG. 13). This process is executed by the user “Nagaharu Edogawa” who operates the ten key, etc. according to the instructions of the menu screen displayed on the terminal 141. Subsequently, if the user presses a sending button displayed on the backup request screen, the terminal 141 reads out the client ID, for example, “00000002” memorized in the internal nonvolatile memory, attaches the client ID “00000002” of the terminal 141 to the backup request and the right data (LT) related to the backup request, that is the right data (LT) held in the data memory unit 131 of the terminal 141, and sends it to the right management server 710. In this situation, the right data for 3 times sent to the right management server 710 may be the LT itself or the right data identification ID 1201 “10000001” with the number of right “3 times” as the remaining usage balance.

When the communication processing unit 113 of the right management server 710 receives the backup request from the terminal 141, it sends the received client ID “00000002” and a confirmation request as a command to request registration confirmation of the client ID to the user information management unit 716 (S1302). When the user information management 716 receives the confirmation request, it searches the user information DB 711 by the client ID “00000002” as a key to confirm if the received client ID “00000002” is registered to the user information DB 711 (S1303). If its registration is not confirmed, the user information management unit 716 sends a confirmation error message to the communication processing unit 113 (S1304), and the communication processing unit 113 receiving this sends an abnormal termination message for a backup process to the terminal 141 (S1305). If its registration is confirmed, the user information management unit 716 reads out the user ID 20 “1234” corresponding to the client ID “00000002” from the user information DB 711, and sends the readout user ID 20 “1234” and a confirmation completion message for the client's registration to the communication processing unit 113 (S1306).

Once the communication processing unit 113 receives the confirmation completion message for the registration, it sends the backup request (command), the right data (LT) for 3 times as the received data for backup, and the user ID 20 “1234” to the right data management unit 715 (S1307). When the right data management unit 715 receives the backup request, it searches the right information DB 712 by the data identification ID “10000001” and the user ID 20 “1234” as keys to see if the data identification ID “10000001” contained in the data for backup exists in correspondence with the user ID 20 “1234” in the right information DB 712, and checks if the data (LT) for backup is the one issued by the server in the past or not (S1308). If the relevant data identification ID “10000001” is not detected here, the right data management unit 715 sends a judgement error message to the communication processing unit 113 (S1309), and the communication processing unit 113 receiving this sends an abnormal termination message for the backup process to the terminal 141 (S1310). If the relevant data identification ID “10000001” is detected, the right data management unit 715 records the right data (LT) for 3 times that is the data for backup to the backup DB 714 (S1311 in FIG. 13, S705 in FIG. 14) and sends a backup completion message for the target data to the communication processing unit (S1312). When the right data (LT) for 3 times is recorded to the backup DB 714 for a case the LT itself is sent for the right data for 3 times for backup, the right data management unit 715 extracts only the right data to show the right for 3 times from the LT format and records it to the backup DB 714 after converting it to the same format as the right information 13 shown in FIG. 10. If the communication processing unit 113 receives a backup completion message from the right data management unit 715, it sends a message of normal termination of the backup to the terminal 141 (S1313).

In the right management server 710 of this embodiment, the right data management unit 715 confirms if the relevant right data is issued by the right management server 710 based on the data identification ID of the right data for backup. Because it does not especially require to have authentication done by the user ID 20 or a password, and does not require any complicated entry operation at the time of the backup request, it is easy to handle.

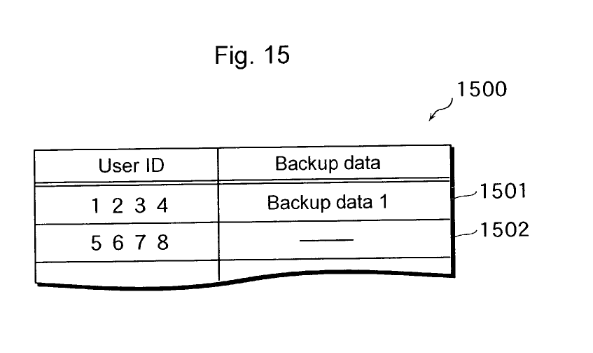

FIG. 15 is a diagram to show a data structure of the backup data managed by the right data management unit 715 in the backup DB 714 shown in FIG. 7. The right data management unit 715 records the data for backup to the backup DB714 as well as describing the relationship between the backup data (LT) and the user making the backup request in the backup management table 1500. To be specific, the user ID 20 is related to the backup data that is the right data backed-up and managed in the backup management table 1500.

In the backup management table 1500, the combination 1501 of the user ID 20 “1234” with the backup data “backup data 1” and the combination 1502 of the user ID “5678” with “no backup data” are recorded. In FIG. 14, this “backup data 1” is the right data (LT) for 3 times managed in the data memory unit 131 of the terminal 141.

Backup is performed only for the right data (LT) managed in the data memory unit 131 of the terminal 141 here. However, if a backup request, for example for the backup data “backup data 2”, is received from other terminal 140 owned by the same user with the user ID 20 “1234” before receiving a restoration request, backup right details of “backup data 1” and “backup data 2” may be combined as “backup data 3”. This “backup data 3” may be related to the user ID 20 “1234” and recorded to the backup DB 714 and the backup management table 1500. In this case, the “backup data 3” may be restored in a lump to the terminal 140 or the terminal 141 whichever makes a restoration request.

The following is an explanation for a case the backup of the right data above is restored to the terminal 141 with reference to FIG. 14 and FIG. 16. In the example of FIG. 14, unused content usage right (for 3 times) remains in the right information DB 712 of the right management server 710 at the time when the backup request from the terminal 141 is normally completed (S705). The right data for 3 times related to the backup request from the terminal 141 remains in the backup DB 714. The unused right data for 3 times remains in the data memory unit 131 of the terminal 140. The right data for 3 times remains as well in the data memory unit 131 of the terminal 141. Later, if the user uses the content once in the terminal 141, the right for once held in the terminal 141 is spent and remains to be for twice (S706). FIG. 16 is a communication sequence diagram that shows communication procedures between the right management server 710 and the terminal 141 for the restoration request from the terminal 141 shown in FIG. 7. The terminal 141 sends the restoration request and the client ID 26 “00000002” of the terminal 141 to the right management server 710 (S1401). Here, the terminal capable of restoration is a terminal that owns the client ID related by the same user ID 20 as the terminal 141 executing the backup. When the communication processing unit 113 of the right management server 710 receives the restoration request, it sends the received client ID 26 “00000002” and the confirmation request as a command to request registration confirmation of the relevant ID to the user information management unit 716 (S1402). When the user information management unit 716 receives the confirmation request, it searches the user information DB 711 to confirm if the user ID 20 corresponding to the received client ID 26 “00000002” is registered to the user information DB 711. (S1403) If its registration is not confirmed here, the user information management unit 716 sends a confirmation error message to the communication processing unit 113 (S1404), and the communication processing unit 113 sends an abnormal termination message to the terminal 141 (S1405). If its registration of the user ID 20 “1234” corresponding to the client ID 26 “00000002” is confirmed, the user information management unit 716 sends a confirmation completion message and the user ID 20 “1234” corresponding to the client ID 26 “00000002” to the communication processing unit 113 (S1406). When the communication processing unit 113 receives the confirmation completion message, it sends the restoration request and the received user ID 20 “1234” to the right data management unit 715 (S1407). When the right data management unit 715 receives the restoration request, it searches the backup management table 1500 of the backup DB 714 to see if the backup data for the received user ID “1234” exists (S1408). If the relevant backup data is not detected here, the right data management unit 715 sends a search error message to the communication processing unit 113 (S1409), and the communication processing unit 113 receiving it sends an abnormal termination message for the restoration to the terminal 141 (S1410). If the relevant backup data “backup data 1” is detected, the right data management 715 combines the detected backup data “backup data 1” with any corresponding data such as a content key in the right information DB 712, generates the LT as the right data for 3 times, and sends the generated LT to the communication processing unit 113 (S1411). When the communication processing unit 113 receives the LT from the right data management unit 715, it sends the received LT to the terminal 141 and terminates the process normally (S1412).

As a result of this, the right data for 3 times memorized in the backup DB of the right management server 710 is returned to the terminal 141 as the LT, and the right data for 3 times held in the backup DB 114 is deleted (S707). As its result, though the terminal 141 had the content usage right only for twice due to consumption of the right for once (S706), it is now allowed to use the content 3 times by this restoration. In such a way, if the user consumes the right (uses the content) in the terminal 141 sometime after the backup before the restoration, it causes a discrepancy in number between the right held in the terminal 141 and the right after the restoration. However, as long as the user performs backup for the right held in his terminal 141, he doesn't loose the right due to some trouble in the terminal, etc. He can use the right held as a backup.

(The Third Embodiment)

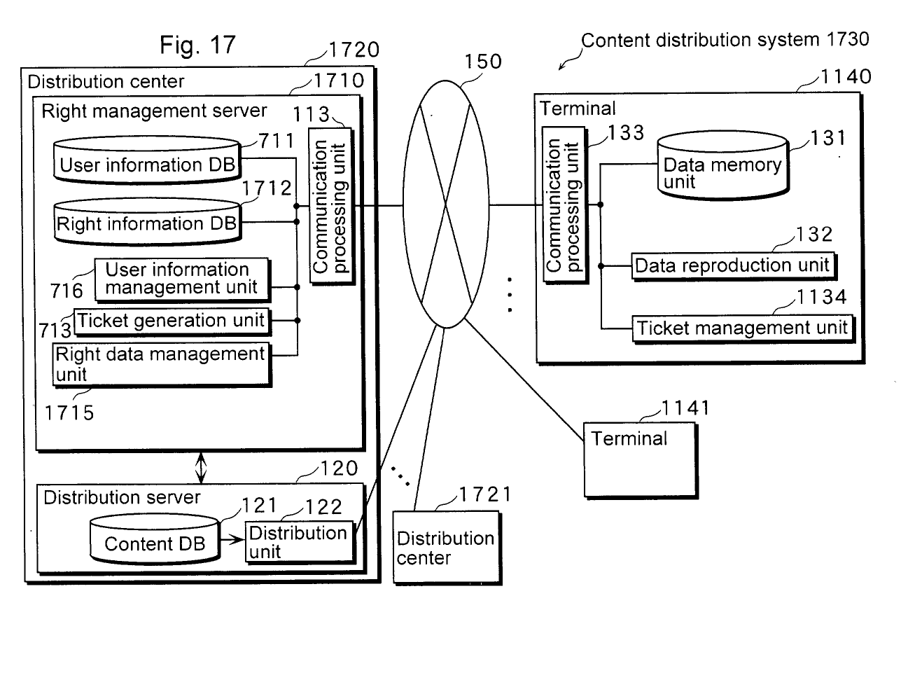

The third embodiment of the present invention is explained as below with reference to FIGS. 17˜20. FIG. 17 is a block diagram to show a structure of the content distribution system 1730 according to the third embodiment. Since the same reference numbers are given to the same structure components as those in the content distribution system 100 or 730 of the first or the second embodiment, explanations for those are omitted. Regarding a point different in the content distribution system 1730 from the content distribution system 100 or 730 of the first or the second embodiment, the right management server 1710 holds an initial value for the right data at the time of right subscription of each user and restores the right data with the initial value to the terminals 1140˜1141 if the terminals 1140˜1141 make a restoration request. The content distribution system 1730 consists of multiple distribution centers 1720˜1721 and multiple terminals 1140˜1141 connected each other via the network 150. The distribution centers 1720˜1721 are equipped with the right management server 1710 and the distribution server 120.

The right management server 1710 is equipped with 2 memory units (a user information DB 711 and a right information DB 1712) such as a hard disk and 4 processing units (a ticket generation unit 713, a right data management unit 1715, a user information management unit 716 and a communication processing unit 113) realized by a program, etc.

The right information DB 1712 holds the same right information as the right information 900 shown in FIG. 10, and it is a memory area to hold the initial value at the time of right subscription by each user. The right information DB 1712 also holds a backup management table to show whether the backup request exists or not by each user. Although the right data management unit 1715 is almost the same as the right data management unit 715, it does not record the right data (LT) related to the backup request from each 1140˜1141, which is different from the right data management unit 715. To be specific, every time the user subscribes a right, the right data management unit 1715 calculates an initial value of the right data by each right data, and records the calculated initial value to the relevant right data. When there is a backup request from each terminal 1140˜1141, which user makes the backup request is recorded by a flag in the backup management table in the right information DB 1712. When there is a restoration request from the terminals 1140˜1141 used by the user who makes the backup request, it executes a process to restore the usage balance for the right information of the user managed in the right information DB 1712 to the initial value of each right data.

In addition to functions in the terminals 140˜141, the terminals 1140˜1141 are a personal computer or a reproduction device exclusively used for the content distribution system 1730, which carries a program to abandon the LT internally held in it when the terminal makes a restoration request to the right management server 1710. Each terminal 1140˜1141 is composed of a data memory unit 131, a data reproduction unit 132, a communication processing unit 133 and a ticket management unit 1134, which are all tamper-resistant. In addition to functions in the ticket management unit 134, the ticket management unit 1134 executes a process to nullify or delete all of the right data (LT) held in the data memory unit 131 if it receives a message showing “Responding to the restoration request”, or “Normal termination of the restoration” from the right management server 1710 when the restoration request is sent to the right management server 1710.

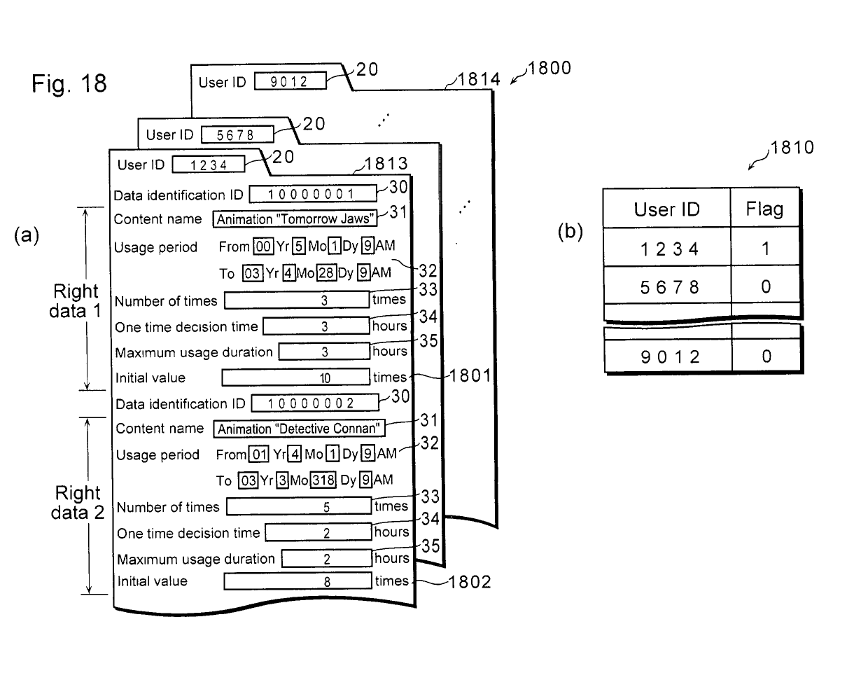

FIG. 18 is a data structure diagram of the right information 1800 and the backup management table 1810 held in the right information DB 1712 shown in FIG. 17. FIG. 18(a) shows a data structure of the right information 1800, and FIG. 18(b) shows a data structure of the backup management table 1810. As shown in FIG. 18(a), the right information 1800 has fields for the initial values 1801˜1802 added for each right data recorded in each right information 1813˜1814, which is different from the right information 900 shown in FIG. 10. Every time the user subscribes the right, the right data management unit 1715 adds the one newly subscribed to the usage balance at that point, calculates the initial value of the relevant right data, and updates the initial values 1801˜1802 with the calculation result. In the same diagram where the right data 1 with data identification ID 30 “10000001”, for example, the LT for 7 times has already been issued from the total subscription for 10 times because the balance in the number of times 33 shows “3 times” and the initial value 1801 shows “10 times”. In the right data 2 with the data identification ID 30 “10000002”, the balance in the number of times 33 shows “5 times” and the initial value 1802 shows “8 times”. This is, for example, for a case the user subscribes the content usage right for “8 times” initially, and then LT for “3 times” are issued to the terminals 1140˜1141.

When the user of the user ID 20 “1234” who holds the content usage right shown in this right information 1813 sends the backup request from the registered terminal 1140 to the right management server 1710, the right data management unit 1715 records that there is the backup request from the user of the user ID 20 “1234” to the backup management table 1810. As shown in FIG. 18(b), in the backup management table 1810, the user ID of each user and its associating flag with a value either “0” or “1” to show whether or not the user makes a backup request are recorded. Here in this example, “1” for the backup request and “0” for no request are recorded. Therefore, in the case as above, “1” is recorded in the flag, which is associated with the user Id “1234” of the backup management table 1810. In the backup management table 1810, other user, for example the user whose user ID is “5678” and the user whose user ID is “9012” has “0” in the flag so that it indicates that they have not made any backup request.

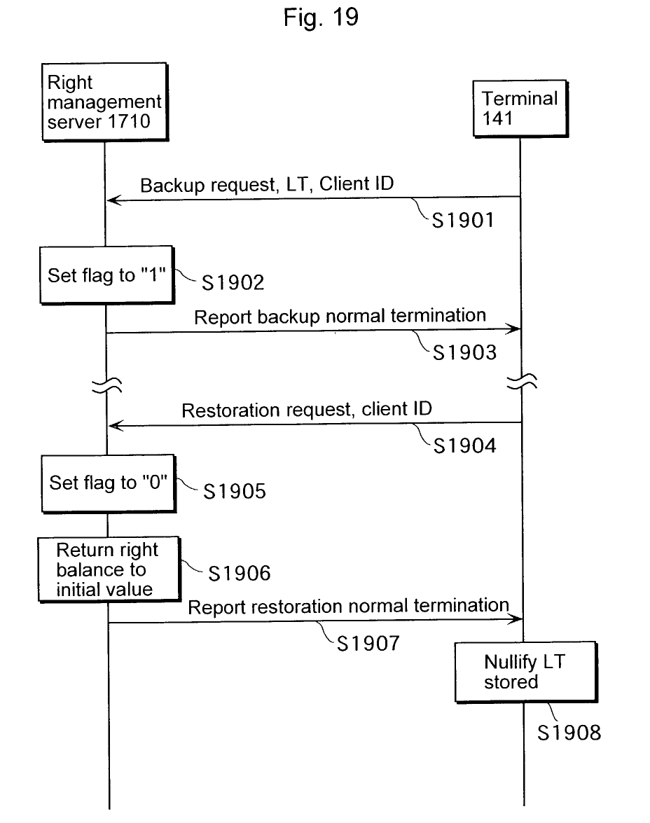

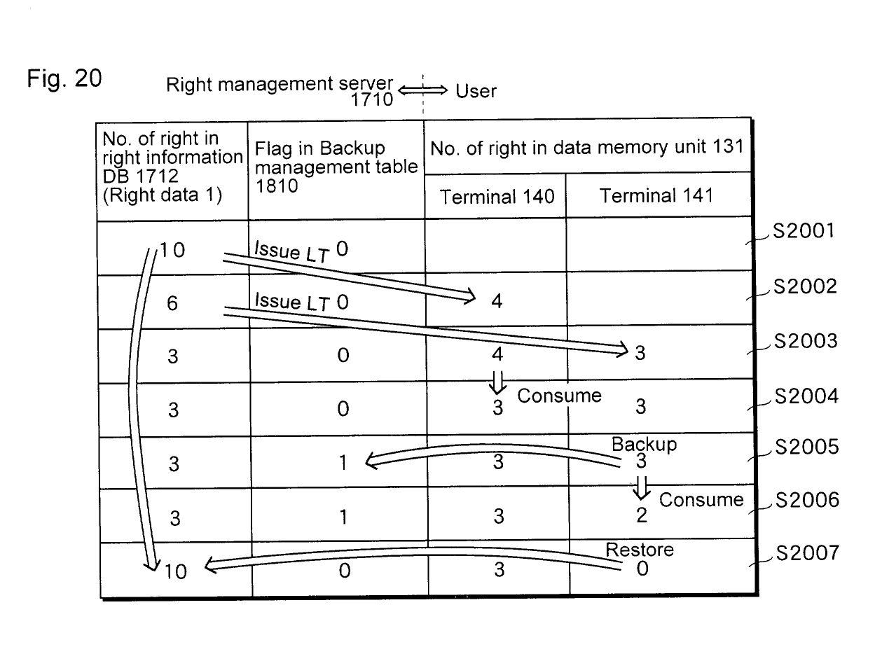

Actions of each unit of the content distribution system 1730 for backup and restoration for the case of the right data being managed as above in the right management server 1710 are explained with reference to a communication sequence diagram in FIG. 19 and a table in FIG. 20. FIG. 19 is a communication sequence diagram that shows communication procedures between the right management server 1710 and the terminal 1141 for backup and restoration requests from the terminal 1141 shown in FIG. 17. As explained in FIG. 13 and FIG. 16, the right management server 1710 collates the data identification ID of the received right data (LT) for the backup request from the terminal 1141, and responds to the request only if the LT is the one issued by the server. Any specific explanation for a method of its collation is omitted since it is the same as the one in the second embodiment. In FIG. 19, the explanation is given to only the case backup and restoration are normally executed as a result of the collation. FIG. 20 is a table to show a sample fluctuation in the numbers of rights affected by backup and restoration, which are respectively managed in the right management server 1710, the terminals 1140 and 1141. In the same diagram, the explanation of the fluctuation in the number of rights in each part of the steps S2001˜S2004 is omitted since they are the same as those in the steps S701˜S704.

In FIG. 20, the flag in the backup management table 1810 is “0” until either of the terminal 1140 or the terminal 1141 makes a backup request. It is presumed that the user with the user ID 20 “1234” sends a backup request from the terminal 1141 to the right management server 1710 when “3 times” is shown in a balance of the right managed by the right data management unit 1715 in the right information DB 1712, and “3 times” is also shown in the number of rights managed by the terminal 1140 and by the terminal 1141 for the user. At this time, to be more specific, the terminal 1141 sends the backup request, the client ID “00000002” of the terminal 1141, and the right data (LT) for 3 times or at least one LT held in the data memory unit 131 to the right management server 710 (S1901 in FIG. 19). The right data management unit 1715 of the right management server 1710 receiving them updates the flag corresponding to the user ID 20 “1234” in the backup management table 1810 to “1” (S2005 and S1902 in FIG. 19). Then, the right management server 1710 sends a normal termination message of the backup to the terminal 1141 (S1903).

Later, if the user uses the content once in the terminal 1141, the right held in the data memory unit 131 of the terminal 1141 is consumed by one and becomes available for twice (S2006 in FIG. 20). Moreover if the user makes a restoration request to the right management server 1710 through the terminal 1141, the terminal 1141 sends the restoration request and the client ID 26 “00000002” of the terminal 1141 to the right management server 710 (S1904). The right data management unit 1715 of the right management server 1710 receiving the restoration request queries the user information management unit 716 to confirm if the received client ID 26 “00000002” is for the same user terminal as the one sending the backup request, and then acquires the user ID 20 “1234”. Additionally, the right data management unit 1715 checks if the flag corresponding to the user ID 20 “1234” of the backup management table 1810 is “1” or not. If it is “1”, it is updated to “0” (S1905). If it is not “1”, the right management server 1710 sends an abnormal termination message of the restoration to the terminal 1141, and terminates the process.

Subsequently, the right data management unit 1715 updates each value in the number of times 33 with the initial values 1801˜1802 for each right data in the right information 1813 corresponding to the user ID 20 “1234” indicated in FIG. 18. For example, in the right data 1 with the data identification ID 30 “10000001”, the remaining balance in the number of times 33 showing “3 times” is updated with “10 times” as the initial value 1801. In the right data 2 with the data identification ID 30 “10000002”, the remaining balance in the number of times 33 showing “5 times” is updated with “8 times” as the initial value 1802 (S1906). Then, the right management server 1710 sends a normal completion message of the restoration to the terminal 1141 (S1907). The terminal 1141 receiving this nullifies all of the right data (LT for twice) held in the data memory unit 131 and normally terminates the restoration (S2007 in FIG. 20).

Although the LT in the terminals 1140˜1141 executing the restoration is nullified (S1908) in the present embodiment, it does not have be nullified.

According to the present embodiment like this, because the restoration process restores the initial value at the time of right subscription, it does not require to perform backup for the actual right data for the backup request from the terminals 1140˜1141. Therefore, it is effective to reduce the process for the backup by the right management server 1710 and lighten a load of the process in the right management server 1710.

(The Fourth Embodiment)

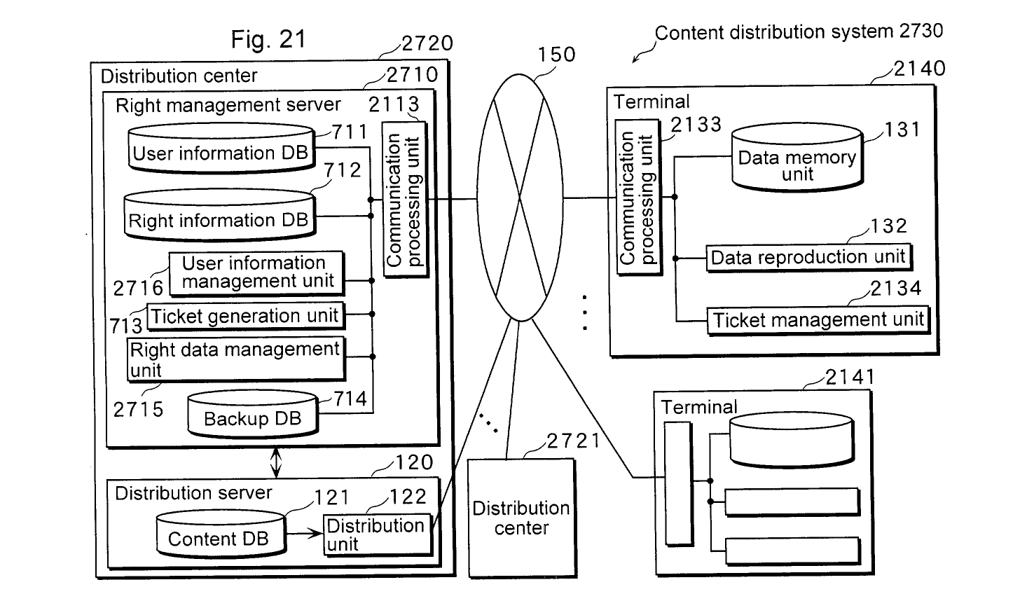

The fourth embodiment of the present invention is explained with reference to FIGS. 21˜24. FIG. 21 is a block diagram to show a structure of the content distribution system 2730 according to the fourth embodiment. The same reference numbers are assigned to the same structure components as those in the content distribution systems 100, 730 and 1730 according to the first, second and third embodiments and explanations for those are omitted. Regarding a point different in the content distribution system 2730 from the content distribution systems 100, 730 and 1730, the right management server 2710 queries about a remaining balance of the right data currently held to other terminal 2141 owned by the same user when it receives a backup request from the terminal 2140 and performs backup for the total of the rights held in each terminal 2140˜2141 owned by the same user and the total of the remaining rights of the user managed in the right management server 2710. The content distribution system 2730 is composed of multiple distribution centers 2720˜2721 and multiple terminals 2140˜2141 connected each other via the communication network 150. The distribution centers 2720˜2721 are equipped with the right management server 2710 and the distribution server 120.

The right management server 2710 consists of 3 memory units (a user information DB 711, a right information DB 712 and a backup DB 714) such as a hard disk and 4 processing units (a ticket generation unit 713, a right data management unit 2715, a user information management unit 2716 and a communication processing unit 2113) realized by a program, etc. When the right data management unit 2715 receives a backup request from the terminals 2140˜2141, it queries other terminals 2140˜2141 used by the same user via the communication processing unit 2113 about the remaining right data currently held in the data memory unit 131, collects its response regarding the query, adds it to the remaining right in the right information DB 712 regarding the user, and then stores the total right data in the backup DB 714. Also, if the right data management unit 2715 receives the restoration request, it updates the right information in the right information DB 712 with the backup data stored in the backup DB 714, sends a normal termination message of the restoration to all of the terminals 2140˜2141 owned by the user, and nullifies the right data (LT) held in the terminals 2140˜2141.

The user information management unit 2716 checks the client ID of other terminal 2140˜2141 owned by the same user based on the client ID of the terminal 2140˜2141 executing backup and restoration requests if the right data management unit 2715 queries the right data for the terminals 2140˜2141 owned by the same user for backup or if it sends a normal termination message of the restoration. The communication processing unit 2113 receives various requests from the terminals 2140˜2141, sends a command and data to each corresponding unit in the right management server 2710, queries about the right data to the terminals 2140˜2141 according to the request of the right data management unit 2715, and sends a response for the query to the right management unit 2715. If the restoration is normally terminated in the right data management unit 2715, a normal termination message of the restoration is sent to all of the terminals 2140˜2141 of the same user making the restoration request.

In addition to functions of the terminals 1140˜1141 in the third embodiment, the terminals 2140˜2141 are a personal computer or a reproduction device exclusively used for the content distribution system 2730 catering a program that abandons the LT held internally if the terminals 2140˜2141 report details of the right data held in the data memory unit 131 according to a query from the right management server 1710 and they receive a normal termination message of the restoration from the right management server 1710. Each terminal 2140˜2141 is equipped with a data memory unit 131, a data reproduction unit 132, a communication processing unit 2133 and a ticket management unit 2134, which are all tamper-resistant. If the communication processing unit 2133 receives a query about the right data or a normal termination message of the restoration from the right management server 2710, it sends this to the ticket management unit 2134. When the ticket management unit 2134 receives the query about the right data from the right management server 2710 via the communication processing unit 2133, it checks the remaining balance of the right data (LT) in the data memory unit 131 and sends the checked remaining balance to the right management server 2710 as its response. Also, if it receives the normal termination message of the restoration from the right management server 2710, it nullifies or deletes all of the right data (LT) in the data memory unit 131.

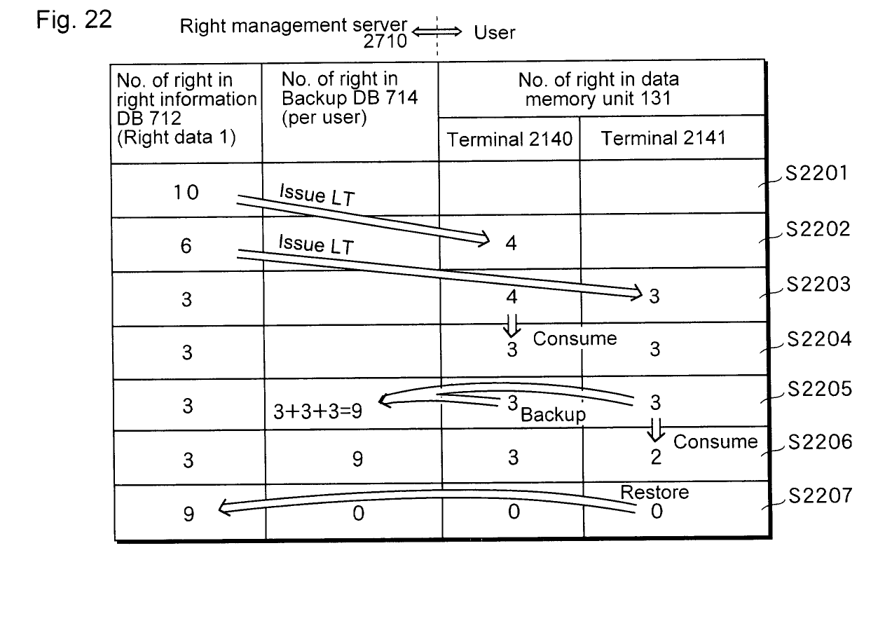

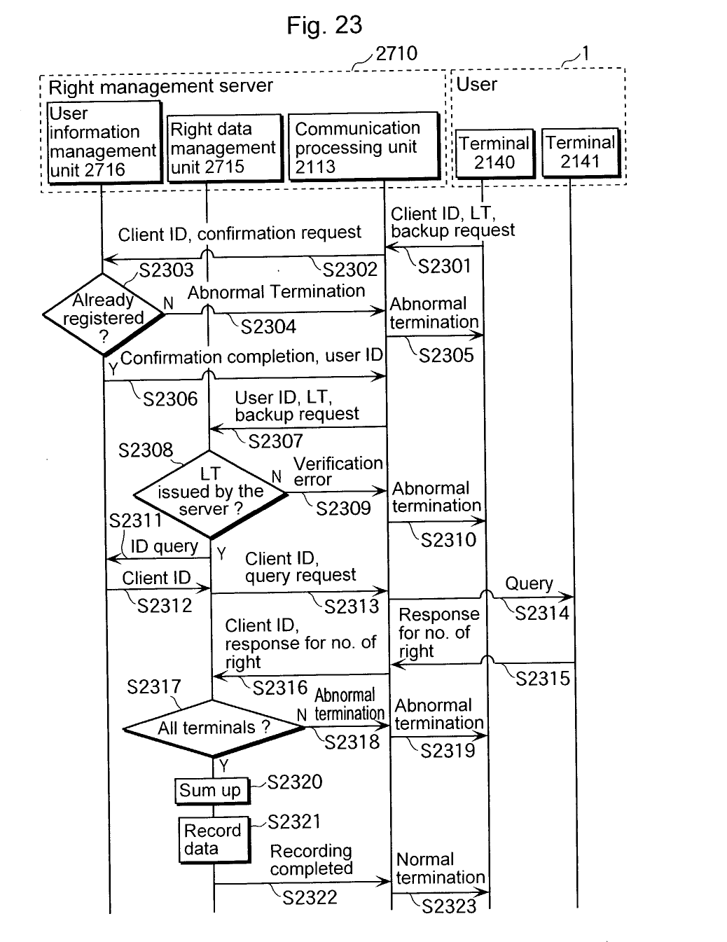

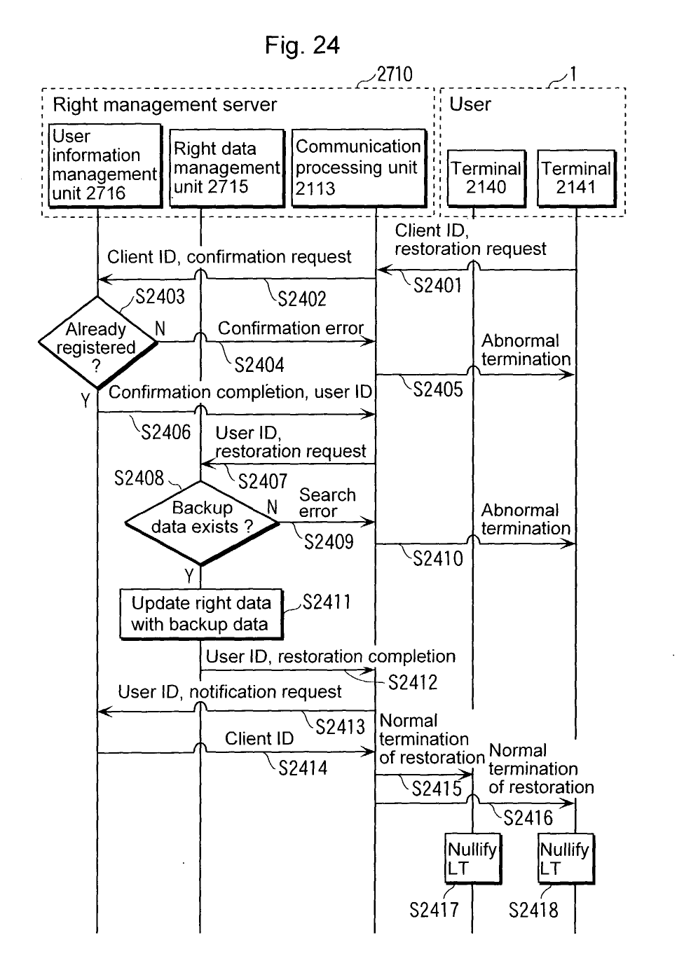

Actions of each unit for backup and restoration processes in the content distribution system 2730 structured in this way are explained with reference to the communication sequence diagrams in FIG. 23 and FIG. 24 and a table in FIG. 22. The explanation is provide for a case the user “Nagaharu Edogawa” whose client ID 20 is “1234” owns the terminal 2140 with the client ID 25 “00000001” and the terminal 2141 with the client ID 26 “00000002” and he makes a backup request from the terminal 2140 and a restoration request from the terminal 2141. Information regarding the user is the same as the one for the user information 11 in FIG. 8, the right information 13 in FIG. 10, the LT in FIG. 12 and the backup data 1501 in FIG. 15 according to the second embodiment. FIG. 22 is a table to indicate a fluctuation example in the number of rights affected by backup and restoration, which is respectively managed in the right management server 2710, the terminal 2140 and the terminal 2141. FIG. 23 is a communication sequence diagram that shows communication procedures among the right management server 2710, the terminal 2140 and the terminal 2141 for a backup request from the terminal 2140 in FIG. 21. In FIG. 22, because the fluctuation in the number of rights in the step S2201˜S2204 is the same as the one in the step S701˜S704 in FIG. 14, their explanations are omitted. The explanation regarding the fluctuation in the number of rights is provided only for the right data 1.

The example of FIG. 22 presumes a backup request is made from the terminal 2140 under the situation that the unused content usage right for 3 times remains in the right information DB 712 of the right management server 2710 and the right data (LT) for 3 times is held respectively in the data memory unit 131 of the terminal 2140 and of the terminal 2141 (S2204). To be specific, the terminal 2140 attaches the “right data 1, 3 times” as data indicating the right and its number held in the data memory unit 131, to at lease one LT and the client ID 25 “00000001” of the terminal 2140 and sends them to the right management server 2710 (S2301 in FIG. 23) The communication processing unit 2113 receiving this sends the received client ID 25 “00000001” and a confirmation request, which is a command to request confirmation if this client ID 25 “00000001” is registered in the user information DB 711, to the user information management unit 2716 (S2302 in FIG. 23). The user information management unit 2716 receiving this searches the user information DB 711 to check if the client ID 25 “00000001” is registered (S2303 in FIG. 23). If it is not registered, it sends an abnormal termination message to the communication processing unit 2113 (S2304 in FIG. 23) According to this, the communication processing unit 2113 sends the abnormal termination message of the backup to the terminal 2140 (S2305 in FIG. 23). If the client ID 25 “00000001” is registered, the user information management unit 2716 sends a confirmation completion message and the user ID 20 “1234” corresponding to the client ID 25 “00000001” to the communication processing unit 2113 (S2306 in FIG. 23) When the communication processing unit 2113 receives a confirmation completion message of the registration, it sends the backup request, the “right data 1, 3 times” as data indicating the right and its number held in the terminal 2140, at least one LT and the user ID 20 “1234” to the right data management unit 2715 (S2307 in FIG. 23). When the right data management unit 2715 receives the backup request, it searches the right information DB 712 to see if the data identification ID “10000001” contained in the LT exists for the user ID 20 “1234” in the right information DB 712 and checks if this LT is the one issued by the server in the past (S2308 in FIG. 23). If the data identification ID “10000001” corresponding to the user ID 20 “1234” in the right information DB 712 is not detected, the right data management unit 2715 sends a judgement error message to the communication processing unit 2113 (S2309 in FIG. 23), and the communication processing unit 2113 receiving this sends an abnormal error message of the backup to the terminal 2140 (S2310 in FIG. 23).

If the relevant data identification ID “10000001” is detected, the right data management unit 2715 queries the user information management unit 2716 about the client ID of the terminal 2141 other than the terminal 2141 with the client ID 25 “00000001” registered to the user information 11 of the user ID 20 “1234” (S2311 in FIG. 23). The user information management unit 2716 checks the user information 11 of the user ID 20 “1234”. If the relevant terminal 2141 is registered, the client ID 26 “00000002” of the terminal 2141 is sent to the right data management unit 2715 (S2312 in FIG. 23). The right data management 2715 sends the client ID 26 “00000002” received from the user information management unit 2716 and a query command that queries the terminal 2141 about the usage balance of the right data to the communication processing unit 2113 (S2313 in FIG. 23). The communication processing unit 2113 receiving this queries about the usage balance of the right data to the terminal 2141 holding the client ID 26 “00000002” (S2314 in FIG. 23). The ticket management unit 2134 of the terminal 2141 receiving the query checks the usage balance of the LT (right data 1, 3 times) held in the data memory unit 131 of the terminal 2141 and sends the response for the number of rights per right as a usage balance of the LT to the right management server 2710 via the communication processing unit 2133 (2315 in FIG. 23). The communication processing unit 2113 receiving this sends the client ID 26 “00000002” of the terminal 2141 originating the query and the data (right data 1, 3 times) as a response for the number of rights to the right data management unit 2715 (S2316 in FIG. 23). The right data management unit 2715 judges whether or not the response for the number of rights is returned from all of the terminals 2141 queried (S2317 in FIG. 23). If the response for the number of rights is not returned from all of the terminals 2141 after a certain period of time, an abnormal termination message is sent to the communication processing unit 2113 (S2318 in FIG. 23). The communication processing unit 2113 receiving this sends the abnormal termination message of the backup to the terminal 2140 (S2319 in FIG. 23).

If the response for the number of rights is returned from all of the terminals 2141 queried, the right data management unit 2715 sums up the usage balance “3 times” of the terminal 2140 sending the backup request, the usage balance “3 times” of other terminal 2141 owned by the same user, and the usage balance “3 times” managed in the right information DB 712 (S2320 in FIG. 23), and records the backup data “right data 1, 9 times” as a result of the summation to the backup DB 714 (S2321 in FIG. 23, S2205 in FIG. 22). In this case, as explained in the second embodiment with reference to FIG. 15, the backup data is related to the user ID 20 and recorded to the backup DB 714. Subsequently, the right data management unit 2715 sends a completion message of the backup data recording in the backup DB 714 to the communication processing unit 2113 (S2322 in FIG. 23). The communication processing unit 2113 receiving this sends a normal completion message of the backup to the terminal 2140 (S2323 in FIG. 23).

Later, if the user uses the content once in the terminal 2141, the right held in the data memory unit 131 of the terminal 2141 is consumed by one and becomes available for twice (S2206 in FIG. 22). FIG. 24 is a communication sequence diagram that shows communication procedures among the right management server 2710, the terminal 2140 and the terminal 2141 for a restoration request from the terminal 2141 shown in FIG. 21. In FIG. 24, because the processes in the steps S2401˜S2410 are the same as those in the steps S1401˜S1410 in FIG. 16, the explanations for them are omitted. When the right management server 2710 receives the restoration request from the terminal 2141, it reads out the user ID 20 “1234” from the user information DB 711 based on the client ID 26 “00000002” attached to the restoration request, and checks if the backup data corresponding to the user ID 20 “1234” exists in the backup management table 1500. As a result of the check, if the “backup data 1” corresponding to the user ID 20 “1234” exists in the backup management table 1500, the right data management unit 2715 updates the right information 13 corresponding to the user ID 20 “1234” in the right information DB 712 with details of the “backup data 1” (S2411). For example, if the details of the backup data 1 is the “right data 1, 9 times”, the right data management unit 2715 updates the number of times 33 in the right data 1 of the right information 13 in the right information DB 712 with “9 times”. Subsequently, the right data management unit 2715 deletes the “backup data 1” of the backup management table 1500 in the backup DB 714, and sends the user ID 20 “1234” of the user and a completion message of the restoration to the communication processing unit 2113 (S2412). The communication processing unit 2113 receiving this sends the user ID 20 “1234” received from the right data management unit 2715 and a notification request, which is a command to request notification of all of the client IDs registered to the user information 11 of the user ID 20 “1234”, to the user information management unit 2716 (S2413). The user information management unit 2716 checks the terminal information from the user information 11 in the user information DB 711, and notifies all of the client IDs registered in relation to the user ID 20 “1234”, which means the client ID 25 “00000001” and the client ID 26 “00000002” to the communication processing unit 2113 (S2414). The communication processing unit 2113 sends a normal termination message of the restoration to all of the terminals 2140˜2141 having the client ID notified (S2415, S2416). If the terminal 2140 and the terminal 2141 receiving this are functioning normally, they nullify or delete all of the LT held in each data memory unit 131 (S2417, S2418). As a result of this, the number of rights in the right data 1 owned by the user “Nagaharu Edogawa” whose user ID 20 is “1234” is restored in the right information DB 712 and becomes “9 times” that is the total number of rights at the time of the backup. Also, the number of rights in the right data 1 held in each terminal 2140˜2141 and the backup DB 714 becomes “0 times”.

Through the right management server 2710 in the present embodiment, if a backup request is made from the terminals 2140˜2141, a usage balance of the right is queried to the terminals of the same user besides the one sending the request. Therefore, it is possible to perform backup for the number of rights actually exists at this point in the right management server 2710 and the terminals 2140˜2141, which provides an effect to realize more realistic backup and restoration.

According to the above embodiment, any right consumed in the terminal at least from its backup request to the restoration is provided at free of charge. Such consumption of the gratuitous right at the terminal side should be anticipated from a nature of backup and restoration. However, to aim at the usage according to the first purpose for providing a service to maintain the user's right from the terminal breakdown and a disaster, a user-based history of the backup and restoration processes may be maintained at the right management server side. For example, the restoration information such as a number of the restoration executed and the total number of the license tickets restored may be recorded by each user in the user information DB. Then, by using these restoration information as a threshold value, permission for the restoration process may be controlled in a predefined scope so that unlimited restorations can be avoided.

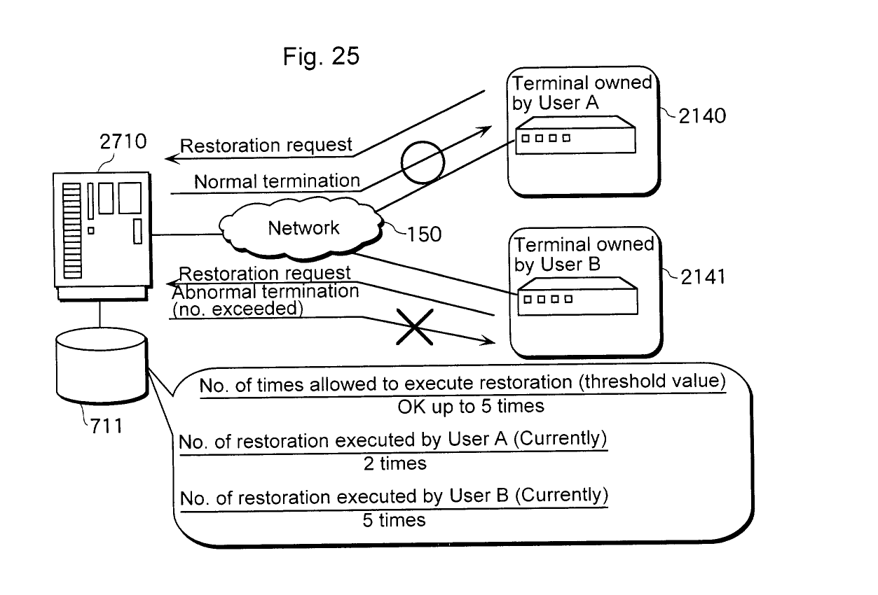

FIG. 25 is a diagram to show a specific example for a case that the number of the restoration executed by each user is recorded in the user information DB 711 shown in FIG. 21 and the restoration permission is controlled within a certain scope. The right management server 2710 records the number of the restoration that have been executed by each user up to the present point in the user information for each user. For example, the restoration executed twice by a User A is recorded in the user information for the User A, whereas the restoration executed five times by a User B is recorded in the user information for the User B. Here, for the case the right management server 2710 controls the restoration with the number of the restorations “5 times” as a threshold value, which means every user is allowed to do the restoration up to 5 times, the right data management unit 2715 refers to the user information of the concerned user in response to a restoration request from the user, and checks if the number of the restoration executed up to the present has reached to the threshold value. Only if the number of the restoration executed by the concerned user is less than the threshold value, the right data management unit 2715 restores the right backed-up in the backup DB 714 according to the restoration request. If the number of the restoration executed by the concerned user has reached at the threshold value, it does not respond to the request.

Therefore, in this example, if the User A makes the restoration request to the right management server 2710, the backup right can be restored since the number of the restoration executed up to now is less than the threshold value “5 times”. In this case, the right data management unit 2715 increases the number of the restoration executed for the User A by 1, notifies it to the user information management unit 2716, and makes the user information management unit 2716 update the user information of the User A with notified the number of the restoration executed. On the other hand, if the User B makes the restoration request to the right management server 2710, the User B cannot get the restoration of the right backed-up in the backup DB 714 since the number of the restoration executed has reached at the threshold value.

According to above, when the right data management unit 2715 receives the restoration request, it checks the number of the restoration executed by the requesting user, and judges whether or not it should respond to the request. However, it can check the number of the restoration executed by the requesting user when it receives the backup request rather than the restoration request, and does not respond to the backup request if the number of the restorations executed has reached at its threshold value. Although the explanation here is provided with the content distribution system 2730 in the fourth embodiment as the example, the method to restrict the restoration (or the backup) in accordance with the number of the restoration executed by each user can be applied to the content distribution system 730 or the content distribution system 1730 in the second or the third embodiment.

At the time of the restoration, it is also possible to restore just a part of the right to the user, for example 80% of the right backed-up to the user, rather than restoring the entire right backed-up to the terminal. Furthermore, a ratio of the restoration can be changed in this case, according to the elapsed time from the day of the backup to the day of the restoration. To be specific, for example, there is a method to restore 90% of the right if the user restores the content usage right within 3 months from its backup date, whereas 80% if it's over 6 months. Or a ratio to restore the right may be changed according to the user's subscription performance of the content usage right. To be more specific, for example, the entire content usage right backed-up is restored for the user whose monthly subscription charge is 50,000 yen or more, while 90% for the user whose monthly subscription charge is 30,000 yen or more. Through the right management server in the present invention, because the server performs backup for the content usage right issued by the server, the ratio of the right restored to the user at the time of the restoration can be set in a variety of ways according to various situations.

According to the explanation is provided in the first embodiment, the right management server 110 analyzes the LT received at the time of backup to confirm if it is the LT issued by the server, and then records the LT itself to the backup DB 114. But it is not only limited to this. In the same way as the right management server 710 according to the second embodiment or the right management server 2710 according to the fourth embodiment, the server may analyze the LT received at the time of backup. As a result of the analysis, if it is the LT issued by the server, it records the right information extracted from the LT to the backup DB 714, and then regenerates the LT at the time of restoration to issue for the user who requested the backup. Contrary to this, in the right management server 710 according to the second embodiment or the right management server 2710 according to the fourth embodiment, the LT itself received at the time of backup may be recorded to the backup DB 114 in stead of extracting right information from the LT received at the time of backup.

According to the explanation, the LT in all of the terminals 140˜141 owned by the user making a restoration request is nullified when the restoration is succeeded (S2417, S2418). But it doesn't have to be nullified.

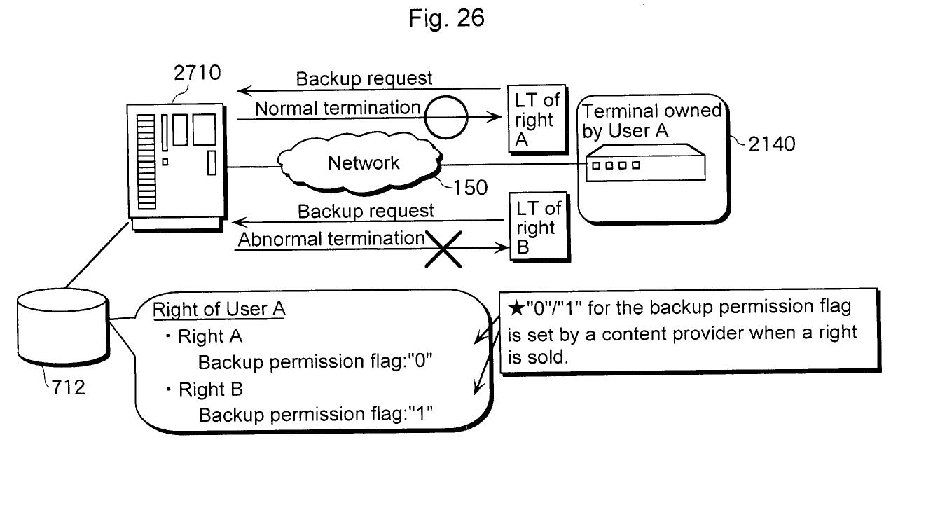

Furthermore, the terminal 2140 or the right management server 2710 in the content distribution system 2730 may decide whether or not backup is performed for the right according to a property of the content usage right for backup. That is because a load of processes on the right management server 2710 may become too big if the number of users is quite large and the right management server 2710 needs to perform backup for all of the rights issued to each user. FIG. 26 is a diagram to show a specific example for a case the backup is controlled according to a backup permission flag appended to each right data in the right information DB 712 shown in FIG. 21. In the content distribution system 2730, for example, depending on a detail of the content distributed, the backup may not be required for the usage right of the content. For example, there is an LT issued as complimentary service like the privileged content usage right under a condition that the user uses it during a specific campaign period, or the usage right for a certain software trial version.

The right management server 2710, for example, sets an item for the backup permission flag by each right data to show if the backup of the concerned right is permitted or not, in each right information within the right information DB 712. Then, a content creator (a content provider) decides whether the backup for each content usage right is required or not. If the backup of the content right concerned is not required, then a value to show prohibition of the backup is set in this field. For example, the value for the backup permission flag can be expressed by “1” for prohibition and “0” for permission.

The right management server 2710 stores the right information composed of the right data containing the item for the backup permission flag as above in the right information DB 712 by each user. If it receives the LT issuance request from the user, the ticket generation unit 713 writes the aforementioned backup permission flag, which is written on the corresponding right data in the right information DB 712, on the LT, and sends it to the terminal 2140 making the request. For example, if the LT requested to be issued is for the content usage right that does not require a backup, the value for the backup permission flag written in the LT is “1”. In the terminal 2140 receiving the LT, the received LT is stored in the data memory unit 131. Later, if the user, for example, calls up a backup request screen from the menu screen, the ticket management unit 2134 in the terminal 2140 reads out designated items on each LT stored in the data memory unit 131, and displays a list of the LT(s) stored in the data memory unit 131.

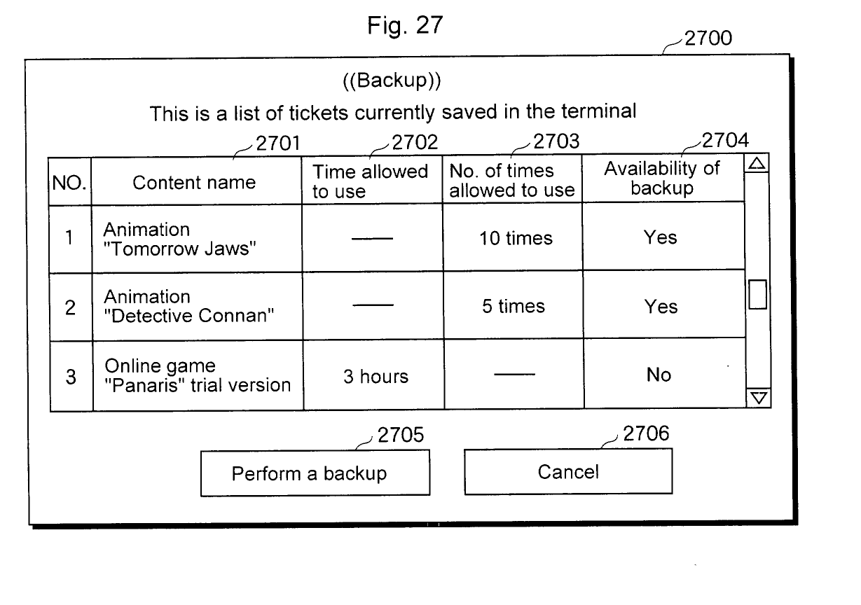

FIG. 27 is a diagram to show an example of the backup request screen 2700 displayed on the terminal 2140. For example, the ticket management unit 2134 checks each item such as the content ID (content name), time available to use, a number of times available to use and the backup permission flag, and displays the list on the backup request screen 2700. As shown in FIG. 27, the list is displayed for details of the 3 LTs among the LTs saved in the data memory unit 131. For each LT, for example, items such as the content name 2701, the time available to use 2702, the number of times available to use 2703 and availability of backup 2704 are indicated.

The content name 2701 indicates a name of the content that can be used with the concerned LT. The time available to use 2702 shows time that the content can be used with the LT. Similarly, the number of times to use 2703 indicates a number of times that the content can be used with the LT. Additionally, the availability of backup 2704 indicates whether the backup of the LT can be accepted or not according to the value in the backup permission flag written on the LT. For example, suppose the third LT displayed on the backup request screen 2700 in FIG. 27 is a complimentary ticket for a trial game provided at free of charge, and hence “1” is written on the backup permission flag on this LT. In this case, the ticket management unit 2134 that checks the backup permission flag on this LT shows “No” in the availability of backup 2704 on the backup request screen 2700. When the user looks at this backup request screen 2700, he can recognize that the animation “Tomorrow Jaws” can be used 10 times with the first LT displayed and backup can be performed for the right indicated on the LT in the right management server 2710. He can also recognize an online game “Panaris” trial version can be used for 3 hours with using the third LT displayed, but backup cannot be performed for this right in the right management server 2710.

The user, by looking at details displayed on the backup request screen, confirms availability of the backup for each LT saved in the data memory unit 131, and then presses a backup button 2705 as “Perform backup” indicated on the backup request screen 2700, which makes the ticket management unit 2134, via the communication processing unit 2133, send the right data indicated on the LT in the data memory unit 131 in order except those LT of which backup permission flag is “1”. In the right management server 2710 receiving such a backup request, the right data management unit 2715 perform backup for the right detail received to the backup DB 714 according to a procedure explained in the above embodiment.

Because backup availability can be judged in each terminal 2140 and the backup data is reduced accordingly, it does not require a heavy load of process in the backup process by the right management server 2710. If a function in the right management server 2710 has more potentiality, the backup availability of the right data (LT) for the backup request received from each terminal 2140 may be judged in the right management server 2710. In such a case, the right data management unit 2715 refers to the backup permission flag set in the concerned right data in the right information DB 712 from the right data identification ID of the right data (LT) for the received backup request, and may perform backup only for the selected right data that requires the backup. Although the explanation is provided here based on the content distribution system 2730 as its example, the right data for backup can be selected in the similar way for the content distribution system according to the first to third embodiment.

Furthermore, the present invention may be realized as a license management server or a terminal device comprising such a content distribution system (license management) system, a backup-restoration method for the license management server or the terminal device, or a program that makes a general purpose computer device execute a distinctive step in the method. And, such a program may be distributed through a communication network or a recording media like CD-ROM, etc.

### INDUSTRIAL APPLICABILITY

As mentioned above, the backup-restoration system according to the present invention is useful as a backup-restoration system in a client-server style system, and especially applicable to a license management system in a content distribution system. The right management server according to the present invention is beneficial as a server that centrally manages client data, and especially applicable to a server that centrally manages a right in the license management system.

1. A backup-restoration system that comprises a sever device performing backup for data held in a terminal device and the terminal device connected to the server device via a communication network,
wherein the terminal device includes:
a data receiving unit operable to receive data issued from the server device; and
a backup request unit operable to request backup of the data, and
the server device includes:
a backup request receiving unit operable to receive the backup request from the terminal device;
a judgement unit operable to judge whether or not the data for backup is issued by the server device; and
a backup unit operable to internally hold the data for backup and perform backup for the data when the data for backup is judged to be the one issued by the server device.

2. The backup-restoration system according to claim 1,
wherein the backup request unit sends specific information that specifies data for backup to the server device, and
the server device further includes an adding unit operable to add additional information of a detail uniquely specifying the server device to the data issued for the terminal device,
in which the judgement unit judges that the data for backup is the one issued by the server device when the additional information is added to the data for backup that is specified by the specific information.

3. The backup-restoration system according to claim 2,
wherein the additional information is URL information of the server device.

4. The backup-restoration system according to claim 2,
wherein the additional information is data identification information that enables the server device to uniquely specify details of the data issued by the server device.

5. The backup-restoration system according to claim 1,
wherein the terminal device further includes an identification information holding unit operable to hold first identification information uniquely specifying the terminal device,
in which the backup request unit further sends the first identification information when the backup request is sent, and
the server device further includes an identification information registration unit operable to register the first identification information of each terminal device,
in which the backup unit performs backup when the backup request is from the terminal device containing the registered first identification information, and when the data for backup is the one issued by the server device as a result of the judgement.

6. The backup-restoration system according to claim 5,
wherein the terminal device further includes a restoration request unit operable to send the first identification information to the server device and request to restore the backup data,
the backup unit associates the data for backup with the first identification information and performs backup for the data, and
the server device further includes:
a searching unit operable to search the backup data associated with the first identification information in the backup unit when the restoration request is received from the terminal device; and
a restoration unit operable to restore the data to the terminal device sending the restoration request when the data concerned exists as a result of the search.

7. The backup-restoration system according to claim 1,
wherein the backup unit extracts data indicating a specific detail from the data for backup and performs backup for the extracted data, and
the restoration unit converts a format of the extracted data to a format of the data for backup, and restores it.

8. A backup-restoration system that comprises a terminal device using content as digital production and a server device managing usage of the content in the terminal device via a communication network,
wherein the server device includes:
a right information memory unit operable to memorize right information regarding a usage right of the content owned by a user who uses the terminal device;
a license ticket issuance unit operable to generate a license ticket that is the right information indicating a part of the usage right owned by the user and issue the license ticket to the terminal device based on a request from the user;
a judgement unit operable to judge whether or not the right related to a backup request from the terminal device is based on the license ticket issued by the server device; and
a backup unit operable to internally hold the right information indicating the usage right related to ownership at the time of the backup request from the user when the right related to the backup request from the terminal device is based on the license ticket issued by the server device as a result of the judgement, and
the terminal device includes:
a license ticket storage unit operable to store the license ticket sent from the server device;
a content usage control unit operable to control the content usage according to the usage right indicated on each license ticket stored; and
a backup request unit operable to request backup of the usage right currently owned by the user based on the license ticket stored.

9. The backup-restoration system according to claim 8,
wherein the license ticket issuance unit writes server device identification information that uniquely specifies the server device on the license ticket and issues the license ticket.

10. The backup-restoration system according to claim 9,
wherein the server device identification information is URL information of the server device.

11. The backup-restoration system according to claim 9,
wherein the server device identification information is right identification information that the server device uniquely specifies the content usage right indicated on the license ticket issued by the server device.

12. The backup-restoration system according to claim 8,
wherein the backup request unit sends a whole or a part of the license ticket to the server device at the time of the backup request, and
the backup unit analyzes the license ticket received at the time of the backup request from the terminal device, generates the right information showing the usage right indicated on the license ticket, and holds the generated right information.

13. The backup-restoration system according to claim 12,
wherein the terminal device further includes a restoration request unit operable to request the server device to restore the backed-up usage right, and
the server device further includes:
a terminal information memory unit operable to memorize terminal information indicating the terminal device owned by each user;
a readout unit operable to specify the user of the terminal device sending the restoration request based on the terminal information, and read out the right information generated for the specified user from the backup unit; and
a restoration unit operable to generate the license ticket indicating the readout right information, and issue the license ticket to the terminal device sending the restoration request.

14. The backup-restoration system according to claim 8,
wherein the terminal device further includes a second restoration request unit operable to request the server device to restore the backed-up usage right, and
the right information memory unit of the server device memorizes an initial value of the content usage right owned by the user, and
the server device further includes:
a terminal information memory unit operable to memorize the terminal information indicating each terminal device owned by each user;
a first user specifying unit operable to specify the user of the terminal device sending the backup request based on the terminal information;
a second user specifying unit operable to specify the user of the terminal device sending the restoration request; and
a second restoration unit operable to restore the content usage right of the user memorized in the right information memory unit to the initial value when the user specified by the second user specifying unit is consistent with the user specified by the first user specifying unit.

15. The backup-restoration system according to claim 1,
the terminal device further includes a storage right reporting unit operable to report the usage right indicated on each license ticket stored to the server device when the terminal device sends the backup request or in response to a query from the server device, and
the server device further includes:
a terminal device information memory unit operable to memorize the terminal device information indicating each terminal device owned by each user;
a terminal device specifying unit operable to specify, based on the terminal device information, the terminal device owned by the same user other than the terminal device sending the backup request when the backup request is received; and
a query unit operable to query about the usage right stored in the terminal device to the terminal device specified by the terminal device specifying unit, and
the backup unit holds the right information indicating the usage right summed from the usage right reported by the terminal device sending the backup request, the usage right reported by the terminal device querying about the usage right and the usage right memorized in the right information memory unit.

16. The backup-restoration system according to claim 15,
wherein the terminal device further includes a third restoration unit operable to request the server device to restore the backed-up usage right, and
the server device further includes a third restoration unit operable to update, for the restoration request from the terminal device, the content usage right of the user memorized in the right information memory unit to the usage right indicated in the right information held in the backup unit.

17. The backup-restoration system according to claim 16,
wherein the terminal device further includes a nullification unit operable to nullify the license ticket stored in the license ticket storage unit at the time of the restoration request.

18. The backup-restoration system according to claim 17,
wherein the server device further includes a reporting unit operable to specify, based on the terminal device information, the terminal device owned by the user receiving the restoration, and report completion of the restoration to the specified terminal device, and
the terminal device further includes a second nullification unit operable to nullify the license ticket stored in the license ticket storage unit when completion of the restoration is reported from the server device.

19. The backup-restoration system according to claim 8,
wherein the terminal device further includes a restoration request unit operable to request the server device to restore the backed-up usage right, and
the server further includes:
a readout unit operable to readout the right information held in the backup unit for the user of the terminal device sending the restoration request from the backup unit;
a restoration unit operable to generate the license ticket indicating the readout right information, and execute the restoration by issuing the license ticket to the terminal device sending the restoration request;
a restoration history holding unit operable to hold historical information of the restoration execution for the user; and
a restoration control unit operable to control the restoration execution by the restoration unit, based on the restoration request from the user, according to the historical information held for the user, and
the restoration unit executes the restoration according to the control of the restoration control unit.

20. The backup-restoration system according to claim 19,
wherein the restoration history holding unit counts a number of the restoration executed by the restoration unit for the user, and holds the historical information indicating the counted number of the restoration executed, and
the restoration control unit verifies availability of the restoration executed by the restoration unit according to the number of the restoration executed that is indicated in the historical information.

21. The backup-restoration system according to claim 19,
wherein the restoration history holding unit counts a number of the license tickets issued by the restoration unit for the user, and holds historical information indicating the counted number of the license tickets, and
the restoration control unit verifies availability of the restoration executed by the restoration unit according to the number of the license tickets indicated in the historical information.

22. The backup-restoration system according to claim 8,
wherein the right information memory unit memorizes the right information including prohibition information that indicates whether the backup of each right information is prohibited or not, and
the backup unit refers to the right information in the right information memory unit indicating the usage right for the backup request sent from the terminal device, and internally holds the right information as a backup process only for the right among the usage right, for which backup is not prohibited by the prohibition information.

23. The backup-restoration system according to claim 8,
wherein the right information memory unit memorizes the right information to which the prohibition information indicating whether the backup of each right information is prohibited or not is added, and
the license ticket issuance unit adds the prohibition information to the license ticket, which is added to the right information in the right information memory unit indicating the usage right requested from the user, and issues the license ticket, and
the terminal device further includes a backup availability indication unit operable to refer to the prohibition information added to the license ticket, and indicates availability of backup of the usage right based on the license ticket stored.

24. The backup-restoration system according to claim 8,
wherein the right information memory unit memorizes the right information including prohibition information that indicates whether the backup of each right information is prohibited or not,
the license ticket issuance unit adds the prohibition information to the license ticket, which is added to the right information in the right information memory unit indicating the usage right requested from the user, and issues the license ticket, and
the backup request unit requests backup of the usage right for which backup is not prohibited by the prohibition information based on the license ticket stored.

25. A server device that performs backup for data held in a terminal device according to a request from the terminal device connected via a communication network, the server device including:
a backup request receiving unit operable to receive the backup request from the terminal device;
a judgement unit operable to judge whether or not data for the backup request is the one issued by the server device; and
a backup unit operable to internally hold the data for backup and performs backup when the data for the backup request is judged to be the one issued by the server device.

26. The server device according to claim 25,
wherein the server device further includes an identification information registration unit operable to register first identification information of each terminal device, and
the backup unit performs backup when the backup request is from the terminal device holding the registered first identification information, and when the data for backup is the one issued by the server device as a result of the judgement.

27. The server device according to claim 26,
wherein the backup unit holds the data for backup in association with the first identification information, and
the server device further includes:
a searching unit operable to search the backup data associated with the first identification information in the backup unit when a restoration request is received from the terminal device; and
a restoration unit operable to restore the data to the terminal device sending the restoration request when the data concerned exists as a result of the search.

28. A right management server device in a content distribution system that comprises a terminal device using content as digital production and the server device managing content usage in the terminal device via a communication network, the right management server including:
a right information memory unit operable to memorize right information regarding a usage right of the content owned by a user who uses the terminal device;
a license ticket issuance unit operable to generate a license ticket as the right information indicating a part of the usage right owned by the user and issue the license ticket to the terminal device based on a request from the user;
a judgement unit operable to judge whether or not the right related to a backup request from the terminal device is based on the license ticket issued by the server device; and
a backup unit operable to internally hold the right information indicating the usage right related to ownership at the time of the backup request from the user when the right related to a backup request from the terminal device is based on the license ticket issued by the server device as a result of the judgement.

29. The right management server device according to claim 28,
wherein the server device further includes:
a terminal device information memory unit operable to memorize terminal device information indicating each terminal device owned by each user;
a terminal device specifying unit operable to specify the terminal device owned by the same user other than the terminal device sending the backup request based on the terminal device information when the backup request is received; and
an query unit operable to query the terminal device specified by the terminal device specifying unit about the usage right stored in the terminal device, and
the backup unit holds the right information indicating the usage right summed from the usage right reported by the terminal device sending the backup request, the usage right reported by the terminal device querying about the usage right, and the usage right memorized in the right information memory unit.

30. A backup-restoration method for a server device to perform backup for data held in a terminal device for a system comprising the server device and the terminal device connected to the server device via a communication network,
wherein the terminal device includes:
a data receiving step that receives data issued from the server device; and
a backup request step that requests backup of the data, and
the server device includes:
a backup request receiving step that receives the backup request from the terminal device;
a judgement step that judges whether or not the data for the backup request is the one issued by the server device; and
a backup step that internally holds the data for backup and performs backup when the data for the backup request is judged to be the one issued by the server device.

31. A backup-restoration method for a server device to perform backup for data held in a terminal device for a system comprising the terminal device using content as digital production and the server device managing usage of the content in the terminal device via a communication network,
wherein the server device includes:
a license ticket issuance step that memorizes right information in advance regarding a usage right of the content owned by a user who uses the terminal device, generates a license ticket as the right information indicating a part of the usage right owned by the user based on a request from the user, and issues the license ticket to the terminal device;
a judgement step that judges whether or not the right related to a backup request from the terminal device is based on the license ticket issued by the server device; and
a backup step that internally holds the right information indicating the usage right related to ownership at the time of the backup request from the user when the right related to the backup request from the terminal device is judged to be the one issued by the server device as a result of the judgement, and
the terminal device includes:
a license ticket storage step that stores the license ticket sent from the server device;
a content usage control step that controls the content usage according to the usage right indicated on the license ticket stored; and
a backup request step that requests backup of the usage right currently owned by the user based on the license ticket stored.

32. A program for a server device to perform backup for data held in a terminal device according to a request from the terminal device connected via a communication network, the program making a computer function as:
a backup request receiving unit operable to receive a backup request from the terminal device;
a judgement unit operable to judge whether or not data for the backup request is the one issued by the server device; and
a backup unit operable to internally hold the data for backup and performs backup for the data when the data for the backup request is judged to be issued by the server device.

33. A program for a server device in a content distribution system comprising a terminal device using content as digital production and a server device managing usage of the content in the terminal device via a communication network, the program making a computer function as:
a right information memory unit operable to memorize right information regarding a usage right of the content owned by a user who uses the terminal device;
a license ticket issuance unit operable to generate a license ticket that is the right information indicating a part of the usage right owned by the user and issue the license ticket to the terminal device based on a request from the user;
a judgement unit operable to judge whether or not the right related to a backup request from the terminal device is based on the license ticket issued by the server device; and
a backup unit operable to internally hold the right information indicating the usage right related to ownership at the time of the backup request from the user when the right related to the backup request from the terminal device is based on the license ticket issued by the server device as a result of the judgement.
